(19) United States
(12) Patent Application Publication
(10) Pub. No.: US 2005/0050767 A1
(43) Pub. Date: Mar. 10, 2005

(54) Wet chemical processing chambers for processing microfeature workpieces

(76) Inventors: Kyle M. Hanson, Kalispell, MT (US); Kert L. Dolechek, Kalispell, MT (US); Paul R. McHugh, Kalispell, MT (US); Gregory J. Wilson, Kalispell, MT (US); Jeffry Alan Davis, Kalispell, MT (US); Randy A. Harris, Kalispell, MT (US)

Correspondence Address: PERKINS COIE LLP;PATENT-SEA, P.O. BOX 1247, SEATTLE, WA, 98111-1247, US

(21) Appl. No.: 10/859,748

(22) Filed: Jun. 3, 2004

Related U.S. Application Data
(60) Provisional application No. 60/476,333, filed on Jun. 6, 2003.
(60) Provisional application No. 60/476,881, filed on Jun. 6, 2003.
(60) Provisional application No. 60/476,786, filed on Jun. 6, 2003.
(60) Provisional application No. 60/476,776, filed on Jun. 6, 2003.

(51) Int. Cl. F26B 5/04

(52) U.S. Cl. 34/618

(57) ABSTRACT

A wet chemical processing chamber comprising a fixed unit, a detachable unit releasably coupled to the fixed unit, a seal contacting the fixed unit and the detachable unit, and a processing component disposed in the fixed unit and/or the detachable unit. The fixed unit can have a first flow system configured to direct a processing fluid through the fixed unit and a mounting fixture for fixedly attaching the fixed unit to a platform or deck of an integrated processing tool. The detachable unit can include a second flow system configured to direct the processing fluid to and/or from the first flow system of the fixed unit. The seal has an orifice through which processing fluid can flow between the first and second flow systems, and the processing component can impart a property to the processing fluid for processing a surface on a microfeature workpiece having submicron microfeatures.

### CROSS-REFERENCE TO RELATED APPLICATIONS

The present invention claims the benefit of U.S. Application No. 60/476,333 filed Jun. 6, 2003; 60/476,881 filed Jun. 6, 2003; 60/476,786 filed Jun. 6, 2003; and 60/476,776 filed Jun. 6, 2003, all of which are incorporated herein in their entirety, including appendices, by reference.

### TECHNICAL FIELD

The present invention is directed toward apparatus and methods for processing microfeature workpieces having a plurality of microdevices integrated in and/or on the workpiece. The microdevices can include submicron features. Particular aspects of the present invention are directed toward a wet chemical processing chamber having a fixed unit and a detachable unit that can be removed quickly for servicing components within the chamber. Additional aspects of the inventions are directed toward an electrochemical deposition chamber having a fixed unit and a detachable electrode unit.

### BACKGROUND

Microdevices are manufactured by depositing and working several layers of materials on a single substrate to produce a large number of individual devices. For example, layers of photoresist, conductive materials, and dielectric materials are deposited, patterned, developed, etched, planarized, and otherwise manipulated to form features in and/or on a substrate. The features are arranged to form integrated circuits, micro-fluidic systems, and other structures.

Wet chemical processes are commonly used to form features on microfeature workpieces. Wet chemical processes are generally performed in wet chemical processing tools that have a plurality of individual processing chambers for cleaning, etching, electrochemically depositing materials, or performing combinations of these processes. FIG. 1 schematically illustrates an integrated tool 10 that can perform one or more wet chemical processes. The tool 10 includes a housing or cabinet 20 having a platform 22, a plurality of wet chemical processing chambers 30 in the cabinet 20, and a transport system 40. The tool 10 also includes lift-rotate units 32 coupled to corresponding processing chambers 30 for loading/unloading the workpieces W. The processing chambers 30 can be rinse/dry chambers, cleaning capsules, etching capsules, electrochemical deposition chambers, or other types of wet chemical processing vessels. The transport system 40 includes a linear track 42 and a robot 44 that moves along the track 42 to transport individual workpieces W within the tool 10. The integrated tool 10 further includes a workpiece storage unit 60 having a plurality of containers 62 for holding workpieces W. In operation, the robot 44 transports workpieces to/from the containers 62 and the processing chambers 30 according to a predetermined workflow within the tool 10.

One challenge of operating integrated wet chemical processing tools is repairing and/or maintaining the processing chambers. In electrochemical deposition chambers, for example, consumable electrodes degrade over time because the reaction between the electrodes and the electrolytic solution decomposes the electrodes. The shape of consumable electrodes accordingly changes causing variations in the electrical field. As a result, consumable electrodes must be replaced periodically to maintain the desired deposition parameters across the workpiece. The electrical contacts that contact the workpiece also may need to be cleaned or replaced periodically. To maintain or repair electrochemical deposition chambers, they can be removed from the tool 10 and replaced with an extra chamber, or they can be serviced in-situ within the tool.

One problem with repairing or maintaining existing wet chemical processing chambers is that the tool must be taken offline for an extended period of time to replace the electrodes or service other components in the processing chambers 30. When the processing chamber 30 is removed from the tool, a pre-maintained processing chamber 30 is mounted to the platform 22 at the vacant station. When the processing chamber 30 is serviced in-situ on the platform, the lift/rotate unit 32 is generally moved out of the way and the operator reaches into the processing chamber 30 from above to repair or replace the components within the chamber 30. For example, to replace consumable electrodes, the worn electrodes are disconnected from the chamber 30 and new electrodes are then installed. This can be an extremely cumbersome process because there is only a limited amount of space in the tool 10 to access the lower portion of the chambers 30 where the electrodes are positioned. After the chamber 30 has been repaired or replaced, the robot 44 and the lift-rotate unit 32 are recalibrated to operate with the processing chamber.

The processes for replacing worn electrodes, servicing other components in-situ within the tool, or replacing a chamber with another chamber require a significant amount of time during which the tool cannot process workpieces. Moreover, the robot 44 and the lift-rotate unit 32 are generally recalibrated to the repaired chamber after each repair; this is a time-consuming process that increases the downtime for repairing or maintaining processing chambers. As a result, when only one processing chamber 30 of the tool 10 does not meet specifications, it is often more efficient to continue operating the tool 10 without stopping to repair the one processing chamber 30 until more processing chambers do not meet the performance specifications. The loss of throughput of a single processing chamber 30, therefore, is not as severe as the loss of throughput caused by taking the tool 10 offline to repair or maintain a single one of the processing chambers 30.

The practice of operating the tool 10 until at least two processing chambers 30 do not meet specifications severely impacts the throughput of the tool 10. For example, if the tool 10 is not repaired or maintained until at least two or three processing chambers 30 are out of specification, then the tool operates at only a fraction of its full capacity for a period of time before it is taken offline for maintenance. This increases the operating costs of the tool 10 because the throughput not only suffers while the tool 10 is offline to replace the wet processing chambers 30 and recalibrate the robot 44, but the throughput is also reduced while the tool is online because it operates at only a fraction of its full capacity. Moreover, as the feature sizes decrease, the electrochemical deposition chambers 30 must consistently meet much higher performance specifications. This causes the processing chambers 30 to fall out of specifications sooner, which results in shutting down the tool more frequently. Therefore, the downtime associated with repairing and/or maintaining electrochemical deposition chambers and other types of wet chemical processing chambers is significantly increasing the cost of operating wet chemical processing tools.

### SUMMARY

The present invention is directed toward wet chemical processing chambers with quick-release detachable units that reduce the downtime for repairing or maintaining processing components in the chambers compared to existing wet chemical processing chambers. In several embodiments of the inventive wet chemical processing chambers, processing components that require periodic maintenance or repair are housed or otherwise carried by the detachable units. For example, an electrode can be one type of processing component that is housed within a detachable unit. Such processing components can be quickly replaced by simply removing the detachable unit from the chamber and installing a replacement detachable unit. The detachable unit is generally accessible without having to move the lift-rotate units or detach the head assembly of the chambers. The detachable unit can also be coupled to the chamber by a quick-release mechanism that is easily accessible. As such, the downtime for repairing or maintaining electrodes or other processing components in chambers is reduced by locating such components in detachable units that can be removed and replaced in only a few minutes compared to several hours for performing the same work on existing wet chemical processing chambers.

In one embodiment, a wet chemical processing chamber in accordance with the invention comprises a fixed unit, a detachable unit releasably coupled to the fixed unit, a seal contacting the fixed unit and the detachable unit, and a processing component disposed in the fixed unit and/or the detachable unit. The fixed unit can have a first flow system configured to direct a processing fluid through the fixed unit and a mounting fixture for fixedly attaching the fixed unit to a platform or deck of an integrated processing tool. The detachable unit can include a second flow system configured to direct the processing fluid to and/or from the first flow system of the fixed unit. The seal has an orifice through which processing fluid can flow between the first and second flow systems, and the processing component can impart a property to the processing fluid for processing a surface on a microfeature workpiece having submicron microfeatures.

Another aspect of the invention is an integrated tool for wet chemical processing of microfeature workpieces. In one embodiment, the tool includes a mounting module having a plurality of positioning elements and attachment elements. In this embodiment, the wet chemical processing chamber can have a fixed unit including a mounting fixture with a first interface member engaged with one of the positioning elements of the mounting module and a first fastener engaged with one of the attachment elements of the mounting module. The mounting module is configured to maintain relative positions between positioning elements such that a transport system for transporting workpieces to/from the wet chemical processing chamber does not need to be recalibrated when the processing chamber is replaced with another processing chamber or when one detachable unit is replaced with another detachable unit.

The present invention is also directed toward electrochemical deposition chambers with at least one electrode in a quick-release detachable unit that reduces the downtime for replacing worn electrodes. In several embodiments of the inventive electrochemical deposition chambers, one or more consumable electrodes are housed within a detachable unit that can be quickly removed and replaced with another detachable unit. Worn electrodes can accordingly be quickly replaced with new electrodes by simply removing the detachable unit with the worn electrodes and installing a replacement detachable unit with new electrodes. The detachable unit is generally a lower portion of the chamber that is accessible without having to move the lift-rotate unit or otherwise open the chamber from above. The detachable units are also coupled to the chamber by a quick-release mechanism that can be easily accessible. As such, the downtime for repairing or maintaining electrodes is greatly reduced by locating the electrodes in quick-release detachable units that can be removed and replaced in only a few minutes compared to the several hours it normally takes for replacing electrodes on existing electrochemical deposition chambers.

In one embodiment, an electrochemical deposition chamber comprises a head assembly and a vessel under the head assembly. The head assembly includes a workpiece holder configured to position a microfeature workpiece at a processing location and electrical contacts arranged to provide electrical current to a layer on the workpiece. The vessel has a fixed unit including a mounting fixture to attach the fixed unit to a deck of a tool, a detachable unit releasably attachable to the fixed unit below the mounting fixture to be positioned below the deck of the tool, an interface element between the fixed unit and the detachable unit to control the flow of processing fluid between the fixed unit and the detachable unit, and an attachment system releasably coupling the detachable unit to the fixed unit. The electrochemical deposition chamber also includes an electrode in the detachable unit. In several particular embodiments, the detachable unit further includes a fluid inlet for providing the processing fluid to the vessel and a fluid outlet for discharging processing fluid from the vessel.

### BRIEF DESCRIPTION OF THE DRAWINGS

FIG. 1 is a schematic top plan view of a wet chemical processing tool in accordance with the prior art.

FIG. 2 is a schematic view illustrating a wet chemical processing chamber in accordance with one embodiment of the invention.

FIG. 3 is a schematic view illustrating the operation of a wet chemical processing chamber in accordance with an embodiment of the invention.

FIG. 4A is cross-sectional view schematically illustrating a wet chemical processing chamber in a detached configuration in accordance with an embodiment of the invention.

FIG. 4B is a cross-sectional view schematically illustrating a wet chemical processing chamber in an assembled configuration in accordance with an embodiment of the invention.

FIG. 5 is cross-sectional view schematically illustrating an electrochemical deposition chamber in a detached configuration in accordance with an embodiment of the invention.

FIG. 6 is a cross-sectional view schematically illustrating an electrochemical deposition chamber in an assembled configuration in accordance with an embodiment of the invention.

FIG. 7 is a cross-sectional view illustrating an electrochemical deposition chamber in accordance with an embodiment of the invention.

FIG. 8 is a cross-sectional view illustrating the electrochemical deposition chamber of FIG. 7 along a different cross section.

FIG. 9 is a cross-sectional view illustrating a vessel for an electrochemical deposition chamber in accordance with another embodiment of the invention.

FIG. 10 is a bottom isometric view of an electrochemical deposition chamber in accordance with an embodiment of the invention.

FIG. 11 is a cross-sectional view illustrating an electrochemical deposition chamber in accordance with another embodiment of the invention.

FIG. 12A is a top isometric view of a carriage for loading/unloading a detachable unit from a wet chemical processing chamber in accordance with an embodiment of the invention.

FIG. 12B is a bottom isometric view of a carriage for loading/unloading a detachable unit of a wet chemical processing chamber in accordance with an embodiment of the invention.

FIG. 13 is a top plan view of a wet chemical processing tool including a wet chemical processing chamber in accordance with another aspect of the invention.

FIG. 14 is an isometric view of a mounting module for holding a wet chemical processing chamber in a wet chemical processing tool in accordance with an embodiment of the invention.

FIG. 15 is a cross-sectional view taken along line 15-15 of FIG. 14 of a mounting module for carrying a wet chemical processing chamber in accordance with an embodiment of the invention.

FIG. 16 is a cross-sectional view showing a portion of a deck of a mounting module in greater detail.

FIG. 17 is a cross-sectional isometric view schematically illustrating a wet chemical processing chamber carried by a mounting module of a wet chemical processing tool in accordance with an embodiment of the invention.

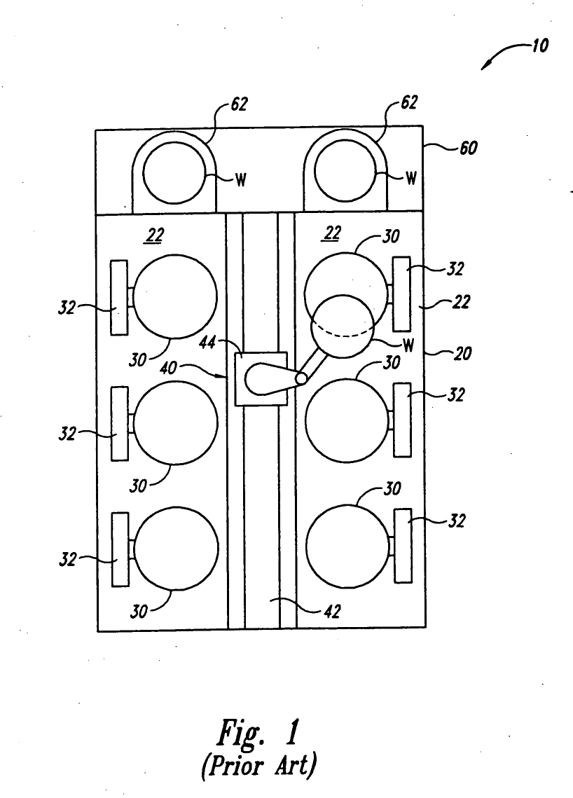

### DETAILED DESCRIPTION

As used herein, the terms “microfeature workpiece” or “workpiece” refer to substrates on and/or in which microdevices are formed. Typical microdevices include microelectronic circuits or components, thin-film recording heads, data storage elements, microfluidic devices, and other products. Micromachines or micromechanical devices are included within this definition because they are manufactured in much the same manner as integrated circuits. The substrates can be semiconductive pieces (e.g., doped silicon wafers or gallium arsenide wafers), nonconductive pieces (e.g., various ceramic substrates) or conductive pieces.

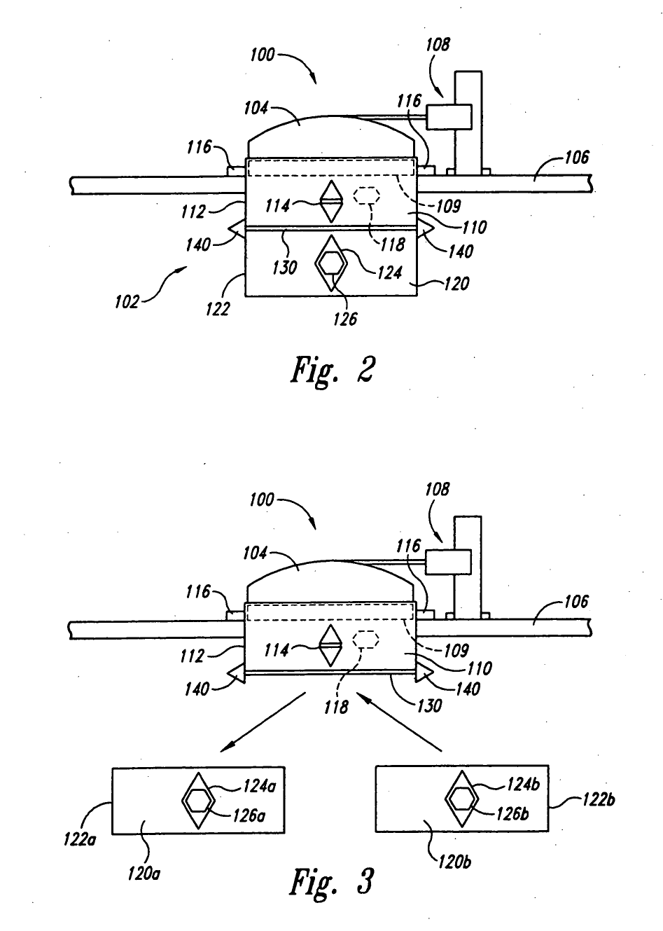

Several embodiments of wet chemical processing chambers for processing microfeature workpieces are described in the context of electrochemical deposition chambers for electrolytically or electrolessly depositing metals or electrophoretic resist in or on structures of a workpiece. The wet chemical processing chambers in accordance with the invention, however, can also be used for etching, rinsing, or other types of wet chemical processes in the fabrication of microfeatures in and/or on semiconductor substrates or other types of workpieces. Several embodiments of wet chemical processing chambers and integrated tools in accordance with the invention are set forth in FIGS. 2-17 and the corresponding text to provide a thorough understanding of particular embodiments of the invention. A person skilled in the art, however, will understand that the invention may have additional embodiments or that the invention may be practiced without several of the details of the embodiments shown in FIGS. 2-17.

A. Embodiments of Wet Chemical Processing Chambers

FIG. 2 schematically illustrates a wet chemical processing chamber 100 that enables quick repair or replacement of components to reduce the downtime for maintaining processing chambers. The processing chamber 100 includes a wet chemical vessel 102 and a head 104. The vessel 102 is carried by a deck 106 of a tool that can include several other processing chambers (not shown) and a workpiece transport system (not shown) for automatically handling workpieces. The vessel 102 contains the processing fluid and several components for directing the processing fluid or otherwise imparting properties to the processing fluid for processing a workpiece. The head 104 is carried by a lift-rotate unit 108 that moves the head 104 to load/unload the workpiece and to position the workpiece at a processing site 109 within the vessel 102. When the processing chamber 100 is an electrochemical deposition station for electroplating materials onto a workpiece, the vessel 102 typically has a fluid flow system and at least one electrode, and the head 104 typically includes a workpiece holder having a contact assembly with a plurality of electrical contacts configured to engage a conductive layer on the workpiece. When the processing chamber 100 is a cleaning chamber or other type of capsule, the vessel 102 includes a plurality of fluid dispensers for flowing a fluid across the workpiece and the head 104 typically includes a workpiece holder. Suitable electrochemical deposition chambers are disclosed in (a) U.S. Pat. Nos. 6,569,297, and 6,660,137, and (b) U.S. Publication Nos. 2003/0068837; 2003/0079989; 2003/0057093; 2003/0070918; 2002/0032499; 2002/0139678; 2002/0125141; 2001/0032788; 2003/0127337; and 2004/0013808, all of which are herein incorporated by reference in their entirety. Additionally, suitable workpiece holders are disclosed in U.S. Pat. No. 6,309,524 and U.S. Pat. No. 6,527,925; and 2002/0000372, all of which are also herein incorporated by reference.

The vessel 102 includes a fixed unit 110 mounted to the deck 106 and a detachable unit 120 carried by the fixed unit 110. The fixed unit 110 can include a chassis 112, a first flow system 114 (shown schematically), and a mounting fixture 116 (shown schematically). The chassis 112 can be a dielectric housing that is chemically compatible with the processing fluid. The chassis 112, for example, can be a high density polymer or other suitable material. The first flow system 114 can be configured to provide the desired flow to the processing site 109. In electrochemical deposition chambers, the first flow system 114 can be configured to provide a flow that has a substantially uniform velocity in a direction normal to the workpiece throughout the processing site 109. The mounting fixture 116 can be flanges or a ring projecting outwardly from the chassis 112 to engage the top surface of the deck 106. The mounting fixture 116 can be configured to precisely locate the fixed unit 110 relative to the deck 106 as explained in more detail below. The fixed unit 110 can further include a processing component 118 (shown schematically) to impart a property to the processing fluid flowing through the fixed unit 110. For example, the processing component 118 can bean electric field shaping element that shapes the electric field in the processing site 109, a filter, a membrane, a nozzle, or another type of fluid dispenser. The processing component 118 can also be any combination of these types of structures. Suitable structures for first flow systems 114, mounting fixtures 116 and processing components 118 for the fixed unit 110 are disclosed in U.S. application Ser. Nos. 09/872,151 and 09/804,697 incorporated by reference above.

The detachable unit 120 of the vessel 102 includes a container 122, a second flow system 124 (shown schematically) configured to direct the processing fluid to and/or from the first flow system 114 of the fixed unit 110, and a processing component 126 (shown schematically) that imparts a property to the processing fluid. The second flow system 124 can include inlets and outlets to deliver processing fluid to the first flow system 114 and to receive processing from the first flow system 114. The first and second flow systems operate together to provide a desired flow of processing fluid at the processing site. The first and second flow systems 114 and 124 can also be configured to provide a forward flow relative to the processing component 126. In a forward flow system, the processing fluid passes the processing component 126 in the detachable unit 120 before the processing fluid reaches the processing site 109. The first and second flow systems can also be configured to provide a reverse flow past the processing component 126. In a reverse flow configuration, the processing fluid passes the processing component 126 after the processing fluid has passed through the processing site 109.

The processing component 126 is disposed in the detachable unit 120. The processing component 126 can be a filter, membrane, or electrode. In addition, the processing component 126 can be an electrode assembly having a plurality of electrodes arranged in a concentric configuration or another configuration suitable for electroplating materials onto the workpiece. In still other embodiments, the processing component 126 can be a combination of filters, membranes, electrodes, dielectric partitions between electrodes that define individual electrode compartments, spray bars with a plurality of nozzles, paddle platers, or other components used to process microfeature workpieces. The processing component 126 is generally a consumable component (e.g., a consumable electrode), a component that collects particulate matter or other undesirable constituents in the processing fluid to protect the surface of the workpiece (e.g., filters of membranes), or other components that may fail or need to be cleaned. The processing component 126 in the detachable unit 120 is accordingly subject to regular maintenance or replacement to maintain the performance of the processing chamber 100 within predetermined specifications. Such processing components can accordingly be quickly replaced with new or refurbished components by simply replacing one detachable unit 120 with a replacement detachable unit without having to move the head 104, the lift-rotate unit 108, or the fixed unit 110.

The vessel 102 also includes a seal 130 to prevent leaking between the fixed unit 110 and the detachable unit 120. The seal is typically positioned between the fixed unit 110 and the detachable unit 120. The seal 130 can include at least one orifice to allow the processing fluid to flow between the first flow system 114 in the fixed unit 110 and the second flow system 124 in the detachable unit 120. In many embodiments, the seal 130 is a gasket with a pattern of orifices to allow fluid to flow between the first and second flow systems 114 and 124. The seal 130 or gasket is typically a compressible member that prevents liquid from leaking between the various flow channels of the flow systems. The seal 130 can also be made from a dielectric material that electrically isolates different fluid flows as they flow between the first and second flow systems 114 and 124. Suitable materials for the seal 130 include VITON® closed cell foams, closed cell silicon, elastomers, polymers, rubber and other materials.

The vessel 102 also includes an attachment assembly 140 for attaching the detachable unit 120 to the fixed unit 110. The attachment assembly 140 can be a quick-release unit, such as a clamp or a plurality of clamps, that guides the detachable unit 120 to a desired orientation with respect to the fixed unit 110 and securely holds the detachable unit 120 to the fixed unit 110. The attachment assembly 140 can be configured to move from a first position in which the detachable unit 120 is secured to the fixed unit 110 and a second position in which the detachable unit 120 can be removed from the fixed unit 110. In several embodiments, as the attachment assembly 140 moves from the second position to the first position, the attachment assembly 140 drives the detachable unit 120 toward the fixed unit 110. This motion compresses the seal 130 and positions the detachable unit 120 at a desired location with respect to the fixed unit 110. The attachment assembly 140 can be a clamp ring, a plurality of latches, a plurality of bolts, or other types of fasteners.

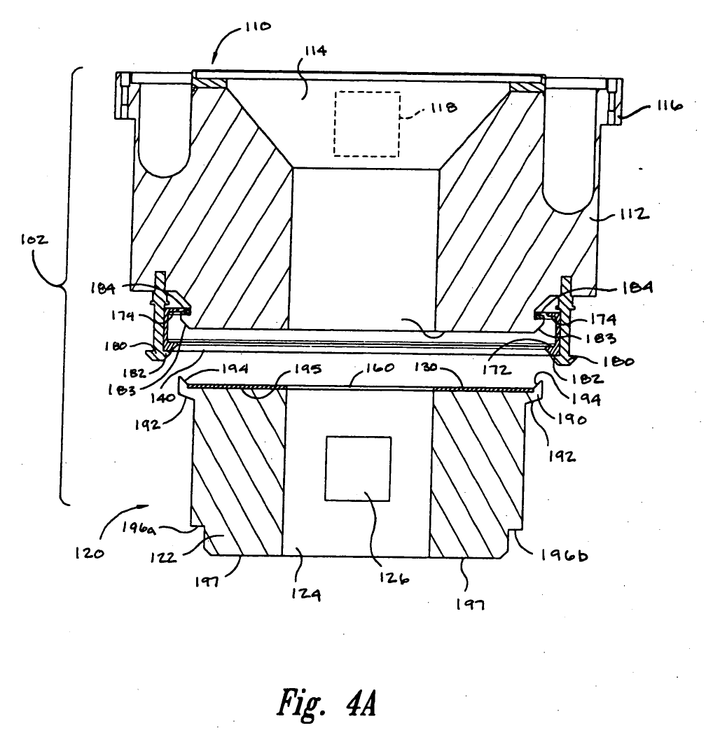

FIG. 3 schematically illustrates the operation of the wet chemical processing chamber 100 for repairing or maintaining processing components in the detachable unit. Like reference numbers refer to like components in FIGS. 2 and 3. A first detachable unit 120a is removed from the fixed unit 110 after the flow system 124a and/or the processing component 126a in the first detachable unit 120a no longer meet specifications. The seal 130 may also be removed, but this is optional. A second detachable unit 120b is then installed by aligning it with the fixed unit 110 and engaging the attachment assembly 140 with the second detachable unit 120b. The second detachable unit 120b can include a flow system 124b and processing components 126b that are new or have been refurbished so that the processing chamber 100 can meet the specifications required for processing microfeature workpieces.

One advantage of the processing chamber 100 illustrated in FIGS. 2 and 3 is that components in need of repair or maintenance can be quickly replaced with new or refurbished components without shutting down the processing chamber 100 for a significant period of time. One detachable unit 120 can be quickly removed from the fixed unit 110, and then a replacement detachable unit 120 can be installed in only a matter of a few minutes. This significantly reduces the downtime for repairing electrodes or other processing components compared to conventional systems that require the components to be repaired in-situ on the tool or require the entire chamber to be removed from the tool.

Another advantage of the processing chamber 100 is that the processing components 126 in the detachable units 120 can be replaced from a location that is easily accessible under the deck 106. As a result, there is no need to move either the fixed unit 110, the head 104, or the lift-rotate unit 108 to replace worn processing components. This further reduces the downtime for maintaining processing components because the head 104 and lift-rotate unit 108 do not need to be repositioned with respect to the fixed unit 110. Moreover, a workpiece transport system that delivers the workpieces to the head 104 and retrieves the workpieces from the head 104 does not need to be recalibrated to the processing chamber 100 because the position between the head 104 and such a workpiece transport system is not changed. The significant reduction in downtime for replacing processing components provided by the processing chamber 100 is expected to significantly increase the productivity of the wet chemical processing tool compared to existing tools.

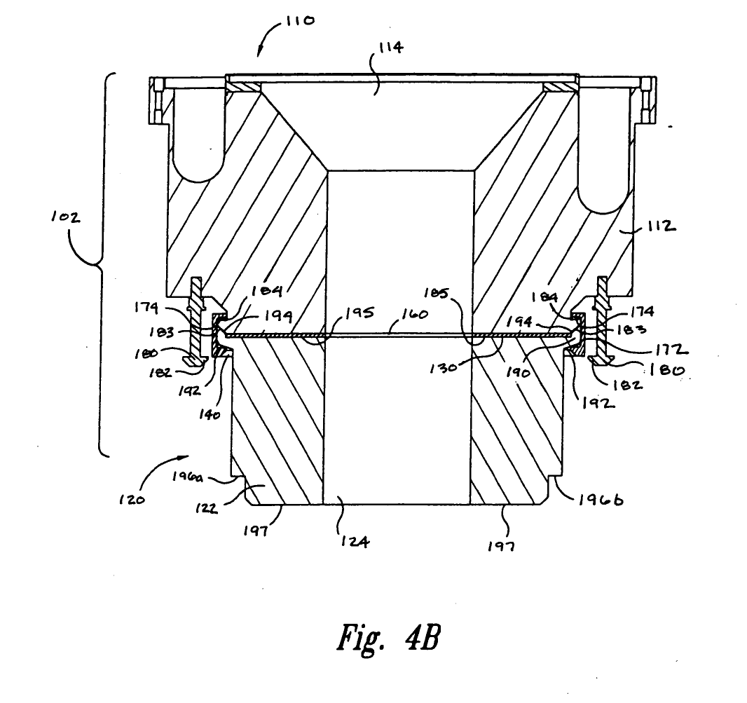

FIG. 4A is a cross-sectional view illustrating an embodiment of the vessel 102 in accordance with the invention. In this embodiment, the fixed unit 110 can further include a plurality of hangers 180 arranged at a common radius with respect to a center line of the fixed unit 110 or in another pattern. The hangers 180 can include shoulders 182 to hold the attachment assembly. For example, the attachment assembly 140 can be a ring that springs radially outwardly to contact the hangers 180 and rest on the shoulders 182 in an open position. The fixed unit 110 further includes a beveled guide surface 183, a bearing ring 184 above the beveled guide surface 183, and a seal surface 185. The guide surface 183 can be an annular surface or a series of arcuate segments inclined upwardly with increasing radius. The bearing ring 184 can be a metal ring having a bearing surface inclined upwardly with decreasing radius. The bearing ring 184 can also be made from other materials that are typically harder than the material of the chassis 112.

The detachable unit 120 can include a rim 190 having a lower surface 192 and an upper surface 194. The lower surface 192 and the upper surface 194 can be inclined upwardly with increasing radius. The upper surface 194, more specifically, can be inclined at an angle to mate with the guide surface 183 of the fixed unit 1;10. The detachable unit 120 can further include a seal surface 195 configured to retain the seal 130, slide channels 196a and 196b, and a bottom surface 197.

The attachment assembly 140 can include a first rim 172 configured to engage the lower surface 192 of the detachable unit 120 and a second rim 174 configured to engage the bearing surface of the bearing ring 184. The attachment assembly 140 can include a latch (not shown) or lever that moves the ring radially inwardly and locks the ring into a fixed position.

FIG. 4B illustrates the vessel 102 after the detachable unit 120 has been attached to the fixed unit 110. In operation, the attachment assembly 140 moves radially inwardly so that the first rim 172 engages the lower surface 192 of the detachable unit 120 and the second rim 174 engages the bearing surface of the bearing ring 184. The radially inward motion of the first rim 172 along the lower surface 192 lifts the detachable unit 120 upwardly toward the fixed unit 110. As the detachable unit 120 moves upwardly, the upper surface 194 engages the guide surface 183 to position the detachable unit 120 at a desired position with respect to the fixed unit 110. The second rim 174 of the attachment assembly 140 moves radially inwardly along the inclined surface of the bearing ring 184 to clamp the seal 130 between the seal surfaces 185 and 195. A lever (not shown) on the attachment assembly 140 can be moved from an open position to a closed position to induce a hoop stress in the attachment assembly 140 for securely holding the detachable unit 120 to the fixed unit 110.

B. General Embodiments of Electrochemical Deposition Vessels

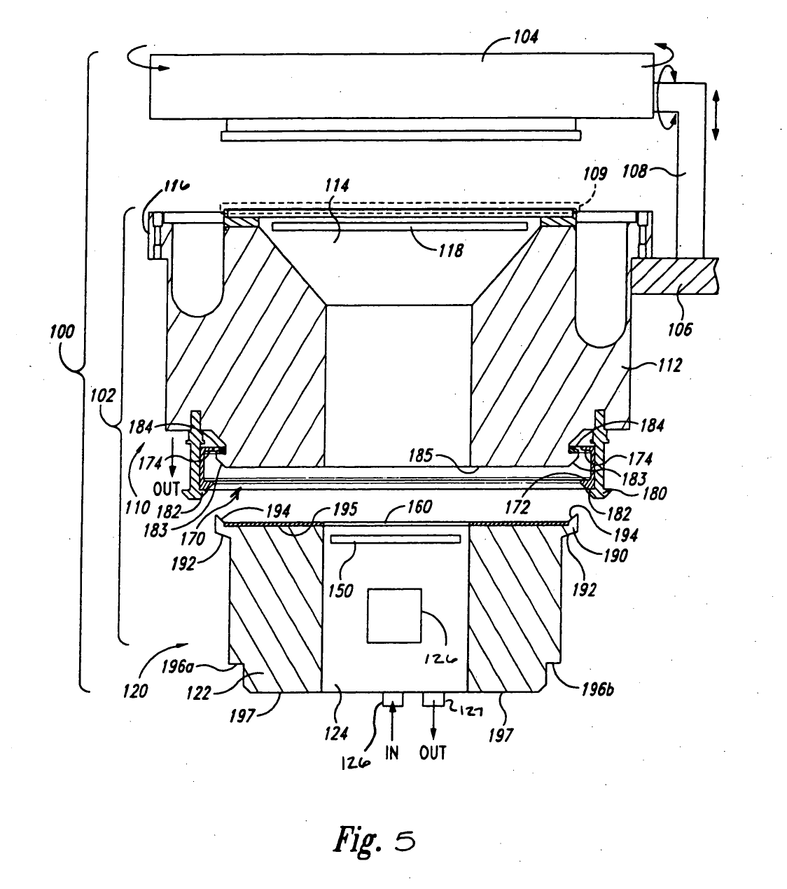

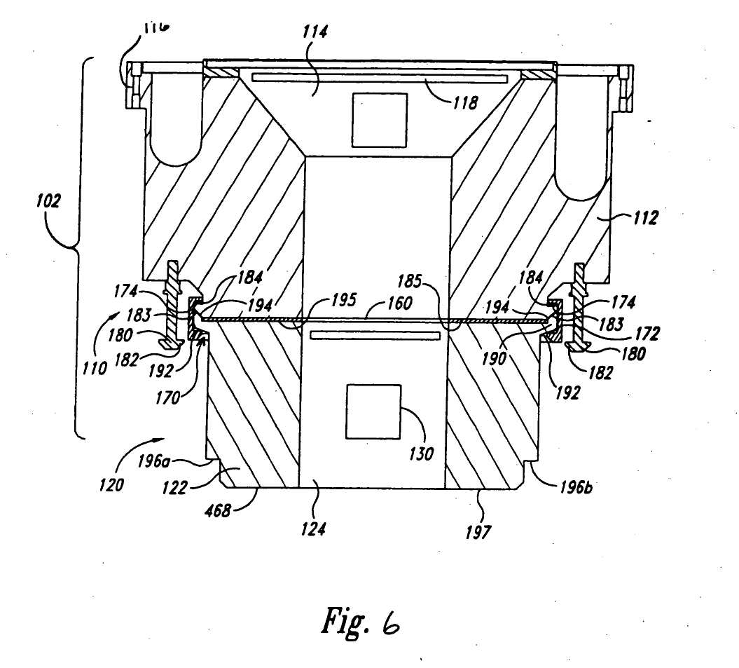

FIG. 5 schematically illustrates a cross-section of an electrochemical deposition chamber 100a that enables quick replacement of electrodes and other components to reduce the downtime for maintaining processing chambers. Several aspects of the electrochemical deposition chamber 100a are similar to the wet chemical chambers 100 described with reference to FIGS. 2-4B. Like reference numbers accordingly refer to like components in FIGS. 2-5. For example, the processing chamber 100a includes the wet chemical vessel 102 and the head 104 (shown schematically).

In this embodiment the processing component 118 of the chamber 100a is an electric field shaping element or field shaping module (shown schematically) that shapes the electric field in the processing site 109. The field shaping element can be a static dielectric insert that controls the current density in the processing site 109. The field shaping element can also be a dynamic member that moves to alter or otherwise control the electrical field at the processing site 109 during a plating cycle. The processing component 118 in this embodiment can also be a filter, membrane, or any combination of these types of structures.

In the embodiment of the chamber 100a shown in FIG. 5, the processing component 126 in the detachable unit 120 includes one or more electrodes (shown schematically) and optional processing components 150 (shown schematically). The optional processing component 150 can be a filter and/or a membrane. Several embodiments of electrodes, filters, and membranes are described below. In a forward flow system, at least a portion of the processing fluid passes the electrode in the detachable unit 120 before the processing fluid reaches the processing site 109. The first and second flow systems can also be configured to provide a reverse flow in which at least a portion of the processing fluid passes the electrode after the processing fluid has passed through the processing site 109.

FIG. 6 illustrates the vessel 102 of the chamber 100a after the detachable unit 120 has been attached to the fixed unit 110. In operation, the detachable unit 120 is connected to the fixed unit 110 as described above with reference to the chamber 100 shown in FIG. 4B.

One advantage of the processing chamber 100a illustrated in FIGS. 5 and 6 is that worn electrodes can be quickly replaced with new or refurbished electrodes without shutting down the processing chamber 100 for a significant period of time. A detachable unit 120 with worn electrodes 130 can be quickly removed from the fixed unit 110, and then a replacement detachable unit 120 with new electrodes 130 can be installed in only a matter of a few minutes. This significantly reduces the downtime for repairing electrodes or other processing components compared to conventional systems that require the components to be repaired in-situ on the tool or require the entire chamber to be removed from the tool.

Another advantage of the processing chamber 100 is that the electrodes and/or other processing components 150 in the detachable units 120 can be replaced from a location that is easily accessible under the deck 106. As a result, there is no need to move either the fixed unit 110, the head 104, or the lift-rotate unit 108 to replace worn processing components. This further reduces the downtime for maintaining processing components because the head 104 and lift-rotate unit 108 do not need to be repositioned with respect to the fixed unit 110.

C. Embodiments of Multiple Electrode Electrochemical Deposition Vessels

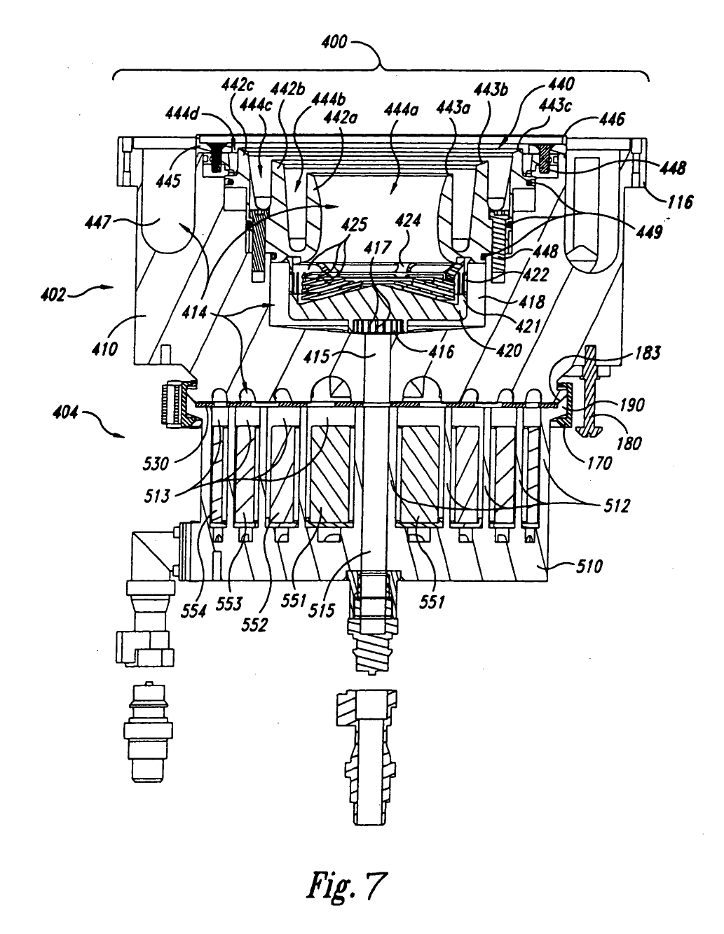

FIGS. 7-9 illustrate aspects of embodiments of vessels having multiple electrodes for electrochemical deposition of materials. Many aspects of these embodiments are described in the context of having four independently operable electrodes in the detachable unit. Each electrode can be controlled independent of the other electrodes such that each electrode can generate an individual current density that can remain constant or can change dynamically during a plating cycle. Suitable processes for operating the electrodes are set forth in U.S. patent application Ser. Nos. 09/849,505; 09/866,391; and 09/866,463, all of which are herein incorporated by reference. Additionally, it will be appreciated that other embodiments of the multiple electrode vessels can have any combination of two or more electrodes such that the invention is not limited to having four electrodes.

FIG. 7 is a cross-sectional view illustrating a vessel 400 having a fixed unit 402 configured to be fixedly attached to a deck (not shown) and a detachable unit 404 releasably attachable to the fixed unit 402. Several aspects of the vessel 400 are similar to those of the chamber 100a, and thus like reference numbers refer to like components in FIGS. 5-9. The detachable unit 404 can be releasably attached to the fixed unit 402 using the attachment assembly 140 and hangers 180 as described above. The detachable unit 404 can accordingly be removed from the fixed unit 402 in a short period of time as described above with respect to the embodiments shown in FIGS. 5 and 6.

The fixed unit 402 includes a chassis 410 having a flow system 414 to direct the flow of processing fluid through the chassis 410. The flow system 414 is one particular embodiment of the first flow system 114 described above. The flow system 414 can be a separate component attached to the chassis 410, or the flow system 414 can be a combination of (a) fluid passageways formed in the chassis 410 and (b) separate components attached to the chassis 410. In this embodiment, the flow system 414 includes an inlet 415 that receives a flow of processing fluid from the detachable unit 404, a first flow guide 416 having a plurality of slots 417, and an antechamber 418. The slots 417 in the first flow guide 416 distribute the flow radially to the antechamber 418.

The flow system 414 further includes a second flow guide 420 that receives the flow from the antechamber 418. The second flow guide 420 can include a sidewall 421 having a plurality of openings 422 and a flow projector 424 having a plurality of apertures 425. The openings 422 can be horizontal slots arranged radially around the sidewall 421 to provide a plurality of flow components projecting radially inwardly toward the flow projector 424. The apertures 425 in the flow projector can be a plurality of elongated slots or other openings that are inclined upwardly and radially inwardly. The flow projector 424 receives the radial flow components from the openings 422 and redirects the flow through the apertures 425. It will be appreciated that the openings 422 and the apertures 425 can have several different configurations. For example, the apertures 425 can project the flow radially inwardly without being canted upwardly, or the apertures 425 can be canted upwardly at a greater angle than the angle shown in FIG. 7. The apertures can accordingly have an inclination ranging from 0°-45°, and in several specific embodiments the apertures can be canted upwardly at an angle of approximately 5°-25°.

The fixed unit 402 can also include a field shaping insert 440 for shaping the electrical field(s) and directing the flow of processing fluid at the processing site. The field shaping insert 440 is one particular embodiment of the processing component 118 in the fixed unit 110 described above. In this embodiment, the field shaping insert 440 has a first partition 442a with a first rim 443a, a second partition 442b with a second rim 443b, and a third partition 442c with a third rim 443c. The first rim 443a defines a first opening 444a. The first rim 443a and the second rim 443b define a second opening 444b, and the second rim 443b and the third rim 443c define a third opening 444c. The fixed unit 402 can further include a weir 445 having a rim 446 over which the processing fluid can flow into a recovery channel 447. The third rim 443c and the weir 445 define a fourth opening 444d. The field shaping unit 440 and the weir 445 are attached to the fixed unit 402 by a plurality of bolts or screws 448, and a number of seals 449 are positioned between the fixed unit 402 and both the field shaping unit 440 and the weir 445.

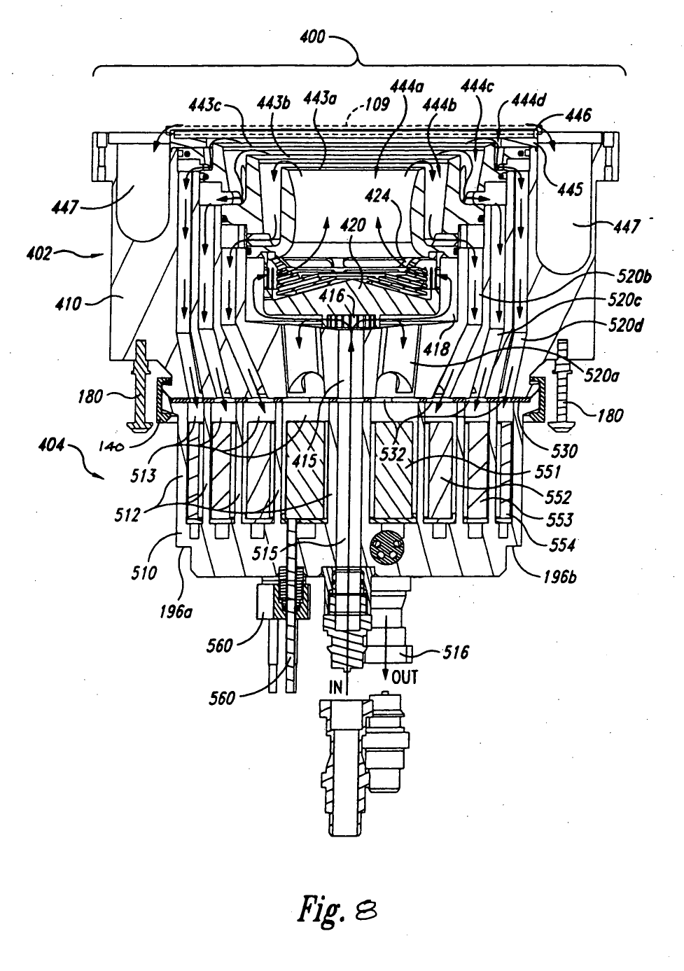

FIG. 8 is a cross-sectional view of the vessel 400 shown in FIG. 7 taken along a different section that shows the interaction between the fixed unit 402 and the detachable unit 404 in greater detail. Referring to FIGS. 7 and 8 together, the detachable unit 404 includes a container 510 that houses an electrode assembly and a second flow system. The electrode assembly is one particular embodiment of the processing component 126 described above, and the second flow system is one particular embodiment of the second flow system 124 described above. The container 510 is also releasably attachable to the chassis 410 as described above. In this embodiment, the container 510 includes a plurality of dividers or walls 512 that define a plurality of compartments 513. The specific embodiment shown in FIGS. 7 and 8 has four compartments 513, but in other embodiments the container 510 can include any number of compartments to house the electrodes individually. The compartments 513 can also define a part of a second flow system through which processing fluid can flow.

The second flow system of the detachable unit 404 includes an inlet 515 that provides the flow to the inlet 415 of the fixed unit 402 and an outlet 516 that receives the fluid flow from the compartments 513. In the specific embodiment shown in FIG. 5, the flow system 414 in the fixed unit 402 further includes a first channel 520a between the antechamber 418 and a first compartment 513, a second channel 520b between the first opening 444b and a second compartment 513, a third channel 520c between the third opening 444c and a third compartment 513, and a fourth channel 520d between the fourth opening 444d and a fourth compartment 513.

The vessel 400 also includes an interface element 530 between the fixed unit 402 and the detachable unit 404. In this embodiment, the interface element 530 is a seal having a plurality of openings 532 to allow fluid communication between the channels 520a-d and the corresponding compartments 513. The seal is a dielectric material that electrically isolates the electric fields within the compartments 513 and the corresponding channels 520a-d.

The vessel 400 can further include a plurality of electrodes disposed in the detachable unit 404. In the embodiment shown in FIGS. 7 and 8, the vessel 400 includes a first electrode 551 in the first compartment 513, a second electrode 552 in the second compartment 513, a third electrode 553 in the third compartment 513, and a fourth electrode 554 in the fourth compartment 513. The electrodes 551-554 can be annular or circular conductive elements arranged concentrically with one another. The electrodes, however, can be arcuate segments or have other shapes and arrangements. In this embodiment, each electrode is coupled to an electrical connector 560 that extends through the container 510 of the detachable unit 404 to couple the electrodes to a power supply. The electrodes 551-554 can each provide a constant current throughout a plating cycle, or the current through one or more of the electrodes 551-554 can be changed during a plating cycle according to the particular parameters of the workpiece. Moreover, each electrode can have a unique current that is different than the current of the other electrodes.

Referring to FIG. 8, the fixed unit 402, the detachable unit 404, and the electrodes 551-554 operate together to provide a desired flow profile of processing fluid and electrical profile at the processing site 109. In this particular embodiment, the processing fluid enters through the inlets 515 and 415 and passes through the first flow guide 416. The fluid flow then bifurcates with a portion of the fluid flowing up through the second fluid guide 420 via the antechamber 418 and another portion of the fluid flowing down across the first electrode 551 via the channel 520a. The upward fluid flow through the second flow guide 420 passes through the flow projector 424 and the first opening 444a. The first electrode 551 accordingly provides an electrical field effectively exposed to the processing site 109 through the first opening 444a defined by the rim 443a of the first partition 442a (FIG. 4). The opening 444a accordingly shapes the field of the first electrode 551 according to the configuration of the rim 443a. A portion of the flow passes upwardly over the rim 443a, goes through the processing site 109, and then flows over the rim 446 of the weir 445. Another portion of the processing fluid flows downwardly through each of the channels 520b-d to the electrodes 552-554. The portion of the flow passing through the second channel 520b passes over the second electrode 552 such that the opening 444b defined by the first rim 443a and the second rim 443b shapes the electrical field of the second electrode 552. Similarly, the flow through the third channel 520c passes over the third electrode 553 and the flow through the fourth channel 520d passes over the fourth electrode 554. The opening 444c accordingly shapes the electrical field from the third electrode 553, and the opening 444d shapes the electrical field from the fourth electrode 554. The flow then passes through the compartments 513 and exits the vessel 400 through the outlet 516.

This flow profile is a reverse flow in which the electrodes 551-554 are downstream from the processing site 109 so that bubbles or particulate matter in the processing fluid generated by the electrodes 551-554 are carried away from the processing site 109. The downstream configuration is expected to be particularly useful for consumable electrodes because they are subject to generating bubbles and particulate matter that can cause defects on the plated surface of a workpiece.

The vessel 400 is expected to significantly reduce the downtime associated with replacing multiple electrodes compared to existing electrochemical deposition chambers. Referring to FIG. 8, all of the electrodes 551-554 can be replaced with new electrodes by simply opening the attachment assembly 140, removing the detachable unit 404 from the fixed unit 402, positioning a replacement detachable unit with new electrodes under the fixed unit 402, and then closing the attachment assembly 140. Because the detachable unit 404 is located externally of the fixed unit 402, an operator does not need to reach through the top opening of the fixed unit 402 to reach the electrodes 551-554 as in conventional chambers. This not only allows faster access to the electrodes 551-554, but it also saves time compared to conventional chambers because the field shaping insert 440 does not need to be removed and then reinstalled. The electrodes 551-554, in fact, do not need to be disassembled from the vessel while the chamber is off-line because the replacement detachable unit can be ready to install as soon as the detachable unit with the worn electrodes is removed. The electrochemical deposition chambers with embodiments of the vessels 102 or 400 can accordingly be brought back online in significantly less time than conventional chambers.

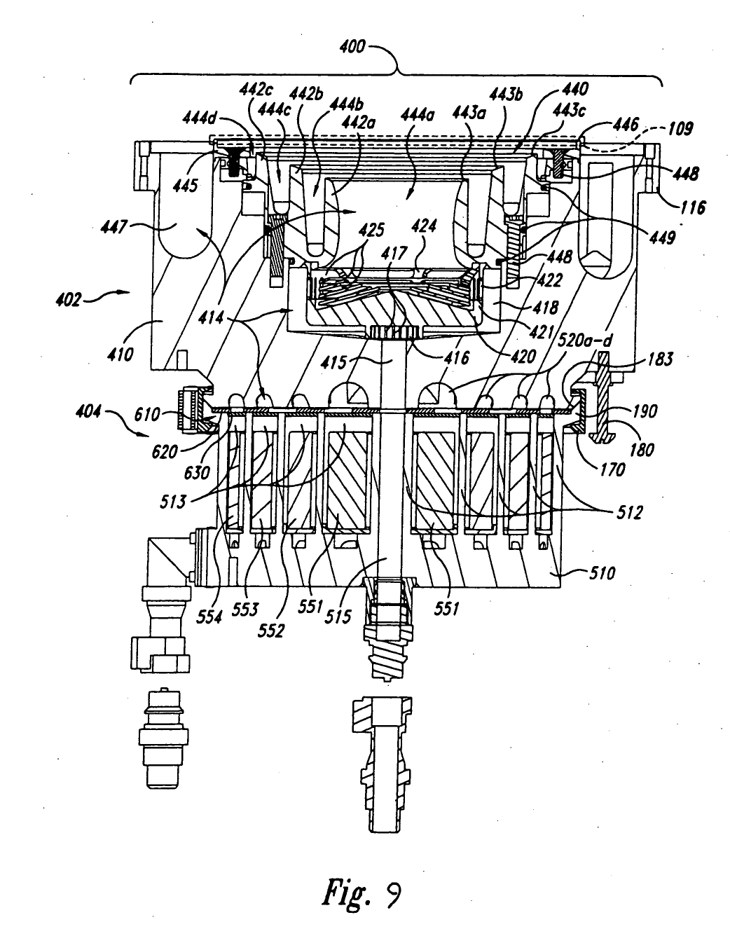

FIG. 9 is a cross-sectional view of another embodiment of a vessel 400. This embodiment is similar to the embodiment shown in FIGS. 7 and 8, and thus like reference numbers refer to like components in these figures. The embodiment of the vessel 400 shown in FIG. 9 includes an interface element 610 having a gasket 620 and a liner 630. The gasket 620 can be positioned between the fixed unit 402 and the detachable unit 404, and the liner 630 can be disposed in the detachable unit 404 and/or the fixed unit 402. The liner 630 can be a membrane or filter that entraps bubbles or particulate matter in the compartments 513 to prevent them from migrating to the processing site 109. In the case of a filter, the processing fluid flows through the liner 630 between the fixed unit 402 and the detachable unit 404 in accordance with the flow for either a forward flow system or a reverse flow system. In the case of a membrane, the liner 630 can be impermeable to fluid flow but allow ions to pass from the electrodes 551-554 through the corresponding channels 520a-d to provide ions for plating onto the surface of the workpiece. The liner 630 can have a plurality of discrete sections positioned in the compartments 513 and/or the channels 520a-d. The gasket 620 can be attached to the liner 630 so the interface element 610 can be installed or removed as a single component.

The embodiment of the vessel 400 shown in FIG. 9 is expected to be very useful in applications where bubbles and particulate matter create defects. It will be appreciated that the liner 630 should further impair bubbles or particulate matter from reaching the processing site 109. The vessel 400 shown in FIG. 9 may also be useful in applications where one processing fluid is used in the fixed unit and another processing fluid is used in the detachable unit. In such an embodiment, the detachable liner 630 can be a membrane that allows ions to flow from the compartments 513 to the channels 520a-520d, but does not allow the processing fluids to flow between the compartments 513 and the channels 520a-520d.

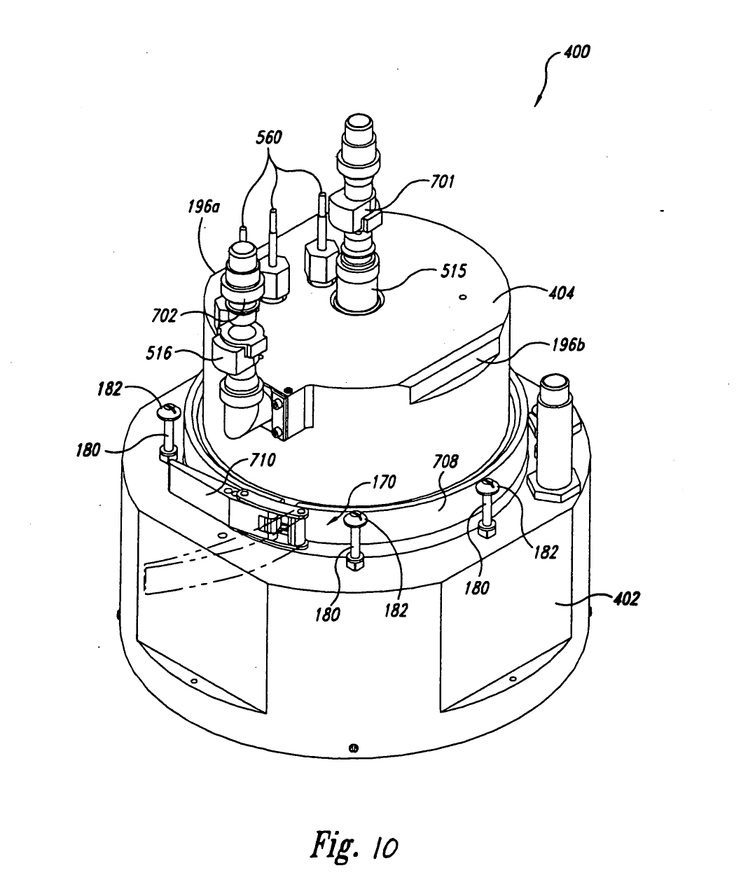

FIG. 10 is a bottom isometric view illustrating various aspects of the vessel 400 in accordance with additional embodiments of the invention. The vessel 400 can further includes a first fitting 701 to couple the inlet 515 with a supply of processing fluid and a second fitting 702 to connect the outlet 516 with a holding tank of processing fluid. In one particular embodiment, the fitting 701 is a female fitting and the inlet 515 is a male fitting, and the fitting 702 is a male fitting and the outlet 516 is a female fitting. By having a female fitting 701 coupled to the inlet 515 and a male fitting 702 coupled to the outlet 516, the processing fluid supply line can only be connected to the inlet 515 and the processing fluid exit line can only be connected to the outlet 516. This configuration accordingly ensures that the detachable unit 404 is installed properly.

FIG. 10 also illustrates the attachment assembly 140 in further detail. In this embodiment, the attachment assembly 140 includes a clamp ring 708 and a latch 710 that moves the clamp ring between a first position having a first diameter and a second position having a second diameter less than the first diameter. As the latch 710 moves the clamp ring from the first position to the second position, the diameter of the clamp ring 708 decreases to clamp the detachable unit 404 to the fixed unit 402.

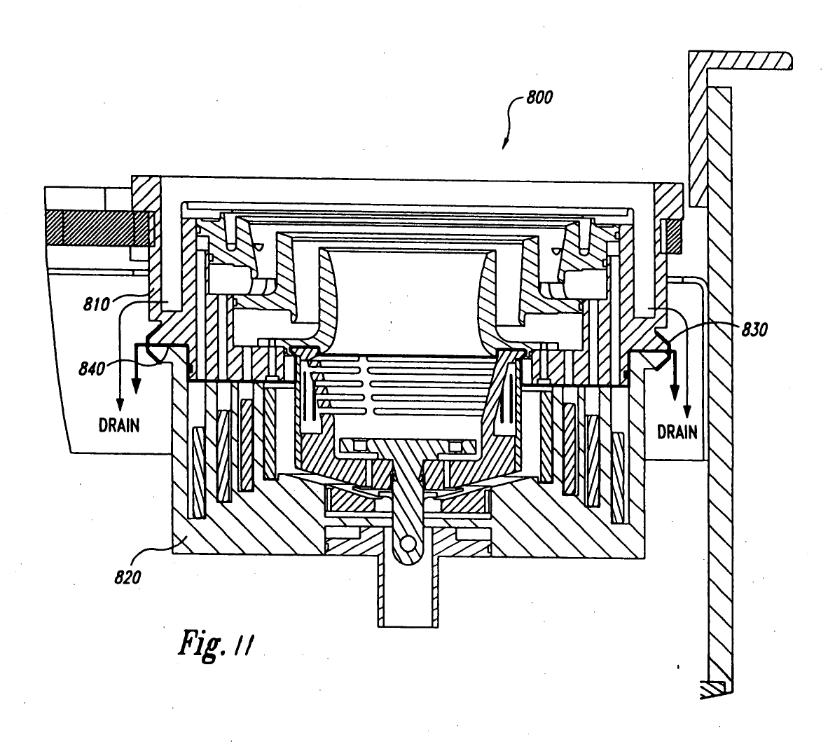

FIG. 11 illustrates another embodiment of a vessel in accordance with the invention. Several features of FIG. 11 are similar to those described above with respect to FIGS. 7-10. The vessel 800 shown in FIG. 11 has a fixed unit 810, a detachable unit 820 releasably attachable to the fixed unit 810 by a clamp 830, and an interface element 840 between the fixed unit 810 and the detachable unit 820. The primary difference between the vessel 800 and the vessel 400 is that the vessel 800 has a non-planer interface element 840 and the vessel 400 has a planer interface element 530.

D. Embodiments of Carriages For Installing/Removing Detachable Unit

The chambers described above can further include carriages under the chambers to install and remove the detachable units. Several embodiments of carriages are described below in the context of the detachable unit 404 shown in FIGS. 7-10, but it will be appreciated that the carriages can work with any detachable units of the invention.

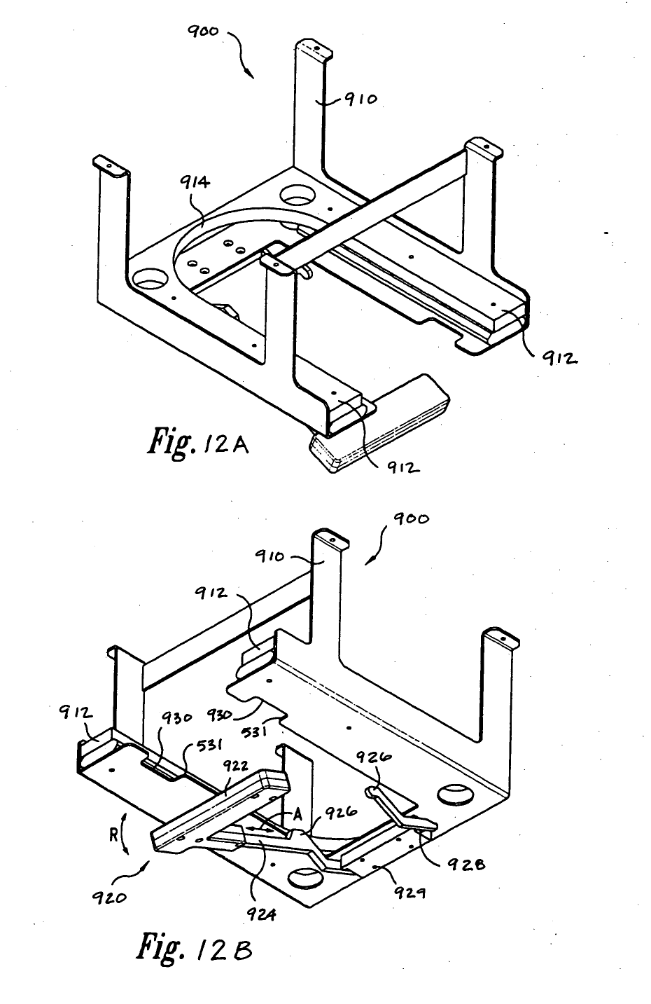

FIG. 12A is a top isometric view of a carriage 900 for installing and removing the detachable unit 404 (FIG. 7). The carriage 900 can include a bracket 910 that mounts to the underside of the deck 106 (FIG. 2) of the tool. The carriage 900 can further include guide rails 912 and an end stop 914. The guide rails 912 receive the slide channels 196a and 196b (FIGS. 4A-B, 5, 6, 8 and 10) and the end stop 914 engages a rounded portion of the detachable unit 404. In operation, an operator slides the detachable unit 404 along the rails 912 until the detachable unit engages the end stop 914.

FIG. 12B is a bottom isometric view illustrating additional aspects of the carriage 900. The carriage 900 can further include an actuator 920 having a handle 922, a shaft 924, and lifters 926 that are moved by the shaft 924. The actuator 920 can further include a rod 928 connected to the lifters 926 and positioned in a joint 929. The rotation of the handle accordingly rotates the rod 928 within the joint 929 to raise and lower the lifters 926. To install a detachable unit, the actuator 920 is moved to a first position as shown in FIG. 12B, and a detachable unit is inserted along the rails 912. The actuator 920 is then lifted upwardly (arrow R) to a second position, which causes the lifters 926 to raise the detachable unit 404 to the fixed unit 402. As the actuator 920 rotates upwardly, the handle 922 passes through a gap 930 in a bottom flange 931 of the bracket 910. The actuator 920 is held in the second position by sliding the handle 922 axially along the shaft 924 so that the flange 931 supports the handle 922.

The carriage 900 further enhances the process of replacing one detachable unit with another. First, the carriage 900 ensures that the detachable unit 404 is generally aligned with fixed unit 402. Second, the carriage ensures that the inlet 515 and the outlet 516 are aligned with the supply line and exit line. Third, the carriage makes it easy to install and remove the detachable unit 404 because the operator does not need to hold the detachable unit 404 against the fixed unit 402 while simultaneously operating the attachment assembly 140. Therefore, the carriage is expected to further reduce the time the replace one detachable unit with another.

E. Embodiments of Integrated Tools

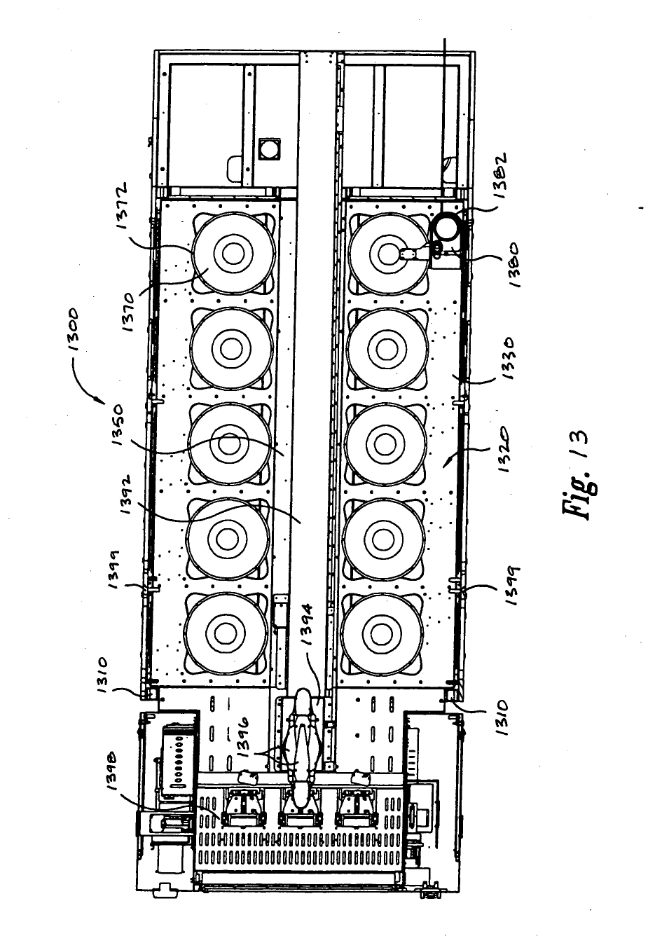

FIG. 13 is a top plan view showing a portion of an integrated tool 1300 in accordance with an embodiment of the invention. In this embodiment, the integrated tool 1300 includes a frame 1310, a dimensionally stable mounting module 1320 mounted to the frame 1310, a plurality of wet chemical processing chambers 1370, and a plurality of lift-rotate units 1380. The tool 1300 can also include a transport system 1390. The mounting module 1320 carries the processing chambers 1370, the lift-rotate units 1380, and the transport system 1390. The wet chemical processing chambers 1370 in the tool 1300 can include vessels having fixed units and detachable units as described above with reference to FIGS. 2-12B.

The frame 1310 of the tool 1300 has a plurality of posts 1311 and cross-bars 1312 that are welded together in a manner known in the art. The mounting module 1320 is at least partially housed within the frame 1310. In one embodiment, the mounting module 1320 is carried by cross-bars 1312 of the frame 1310, but the mounting module 1320 can stand directly on the floor of the facility or other structures in other embodiments.

The mounting module 1320 is a rigid, stable structure that maintains the relative positions between the wet chemical processing chambers 1370, the lift-rotate units 1380, and the transport system 1390. One aspect of the mounting module 1320 is that it is much more rigid and has a significantly greater structural integrity compared to the frame 1310 so that the relative positions between the wet chemical processing chambers 1370, the lift-rotate units 1380, and the transport system 1390 do not change over time. Another aspect of the mounting module 1320 is that it includes a dimensionally stable deck 1330 with positioning elements at precise locations for positioning the processing chambers 1370 and the lift-rotate units 1380 at known locations on the deck 1330. In one embodiment (not shown), the transport system 1390 can be mounted directly to the deck 1330. In other embodiments, the mounting module 1320 also has a dimensionally stable platform 1350 and the transport system 1390 is mounted to the platform 1350. The deck 1330 and the platform 1350 are fixedly positioned relative to each other so that positioning elements on the deck 1330 and positioning elements on the platform 1350 do not move relative to each other. The mounting module 1320 accordingly provides a system in which wet chemical processing chambers 1370 and lift-rotate units 1380 can be removed and replaced with interchangeable components in a manner that accurately positions the replacement components at precise locations on the deck 1330.

The tool 1300 is particularly suitable for applications that have demanding specifications which require frequent maintenance of the wet chemical processing chambers 1370, the lift-rotate units 1380, or the transport system 1390. A wet chemical processing chamber 1370 can be repaired or maintained by simply detaching the chamber from the processing deck 1330 and replacing the chamber 1370 with an interchangeable chamber having mounting hardware configured to interface with the positioning elements on the deck 1330. Because the mounting module 1320 is dimensionally stable and the mounting hardware of the replacement processing chamber 1370 interfaces with the deck 1330, the chambers 3170 can be interchanged on the deck 1330 without having to recalibrate the transport system 1390. This is expected to significantly reduce the downtime associated with repairing or maintaining processing chambers 1370 so that the tool can maintain a high throughput in applications that have stringent performance specifications. This aspect of the tool 1300 is particularly useful when the fixed unit 110 (FIG. 2) must be removed to repair the chamber.

The transport system 1390 retrieves workpieces from a load/unload module 1398 attached to the mounting module 1320. The transport system 1390 includes a track 1392, a robot 1394, and at least one end-effector 1396. The track 1392 is mounted to the platform 1350. More specifically, the track 1392 interfaces with positioning elements on the platform 1350 to accurately position the track 1392 relative to the chambers 1370 and the lift-rotate units 1380 attached to the deck 1330. The robot 1394 and end-effectors 1396 can accordingly move in a fixed, dimensionally stable reference frame established by the mounting module 1320. The tool 1300 can further include a plurality of panels 1399 attached to the frame 1310 to enclose the mounting module 1320, the wet chemical processing chambers 1370, the lift-rotate units 1380, and the transport system 1390 in a cabinet. In other embodiments, the panels 1399 on one or both sides of the tool 1300 can be removed in the region above the processing deck 1330 to provide an open tool.

F. Embodiments of Dimensionally Stable Mounting Modules

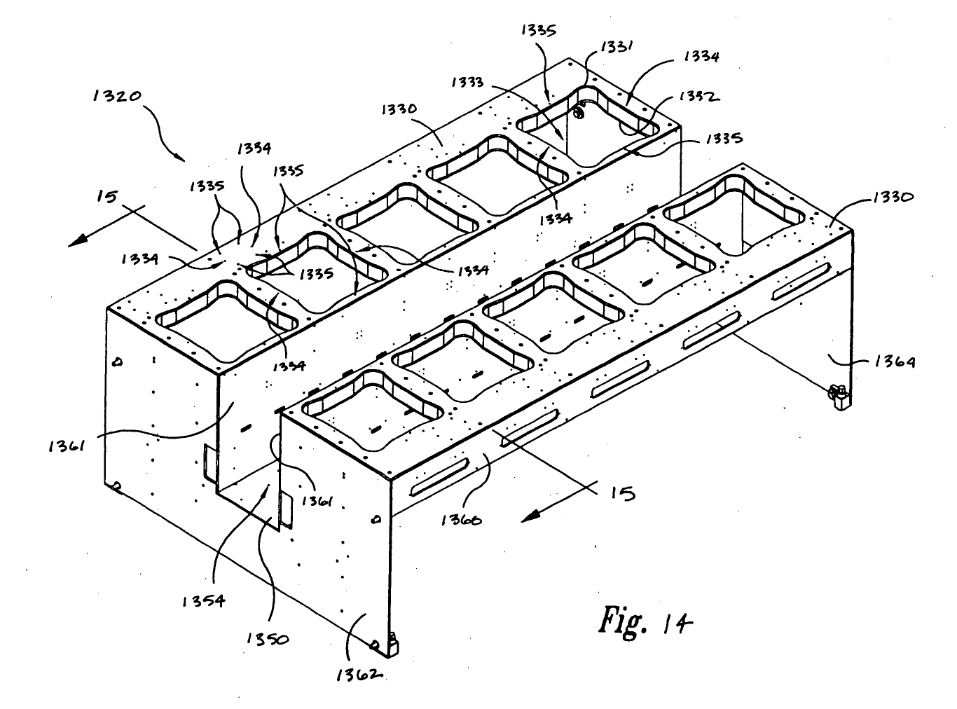

FIG. 14 is an isometric view of a mounting module 1320 in accordance with an embodiment of the invention for use in the tool 1300. In this embodiment, the deck 1330 includes a rigid first panel 1331 and a rigid second panel 1332 superimposed underneath the first panel 1331. The first panel 1331 can be an outer member and the second panel 1332 can be an interior member juxtaposed to the outer member. The first and second panels 1331 and 1332 can also have different configurations than the configuration in FIG. 14. A plurality of chamber receptacles 1333 are disposed in the first and second panels 1331 and 1332 to receive the wet chemical processing chambers 1370 (FIG. 13).

The deck 1330 can further include a plurality of positioning elements 1334 and attachment elements 1335 arranged in a precise pattern across the first panel 1331. The positioning elements 1334 can be holes machined in the first panel 1331 at precise locations and with precise dimensions to receive dowels or pins that interface with the wet chemical processing chambers 1370 (FIG. 13). In other embodiments, the positioning elements 1334 can be pins, such as cylindrical pins or conical pins, that project upwardly from the first panel 1331 to be received by mating structures in the wet chemical processing chambers 1370. The deck 1330 has a first set of positioning elements 1334 located at each chamber receptacle 1333 to accurately position the individual wet chemical processing chambers at precise locations on the mounting module 1320. The deck 1330 can also include a second set of positioning elements 1334 near each receptacle 1333 to accurately position individual lift-rotate units 1380 at precise locations on the mounting module 1320. The attachment elements 1335 can be threaded holes in the first panel 1331 that receive bolts to secure the chambers 1370 and the lift-rotate units 1380 to the deck 1330.

The mounting module 1320 also includes exterior side plates 1360 along longitudinal outer edges of the deck 1330, interior side plates 1361 along longitudinal inner edges of the deck 1330, and endplates 1362 and 1364 attached to the ends of the deck 1330. The transport platform 1350 is attached to the interior side plates 1361 and the end plates 1362 and 1364. The transport platform 1350 includes positioning elements 1354 for accurately positioning the track 1392 (FIG. 13) of the transport system 1390 on the mounting module 1320. The transport platform 1350 can further include attachment elements, such as tapped holes, that receive bolts to secure the track 1392 to the platform 1350.

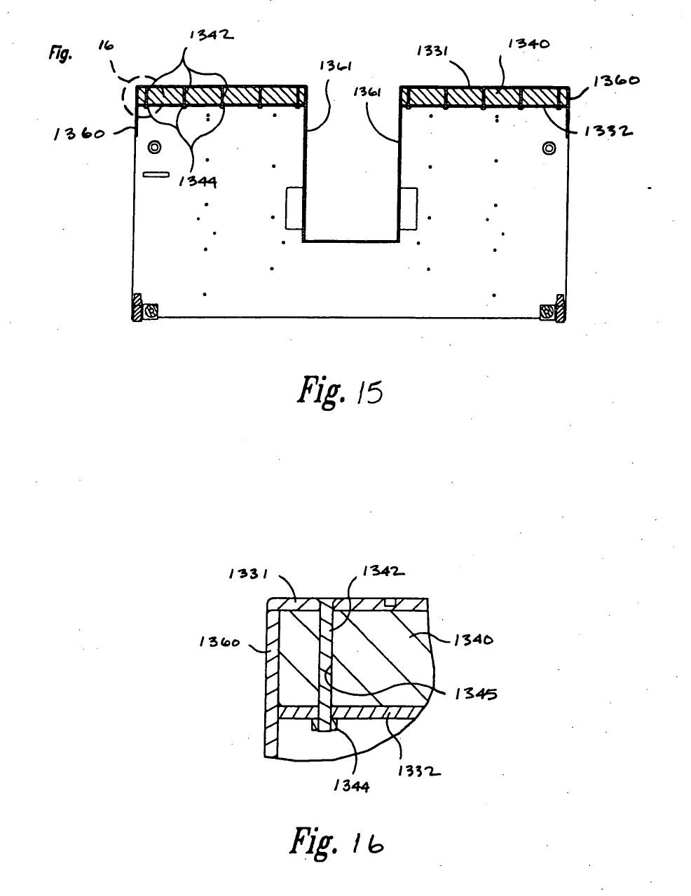

FIG. 15 is a cross-sectional view illustrating one suitable embodiment of the internal structure of the deck 1330, and FIG. 16 is a detailed view of a portion of the deck shown in FIG. 15. In this embodiment, the deck 1330 includes bracing 1340, such as joists, extending laterally between the exterior side plates 1360 and the interior side plates 1361. The first panel 1331 is attached to the upper side of the bracing 1340, and the second panel 1332 is attached to the lower side of the bracing 1340. The deck 1330 can further include a plurality of throughbolts 1342 and nuts 1344 that secure the first and second panels 1331 and 1332 to the bracing 1340. As best shown in FIG. 16, the bracing 1340 has a plurality of holes 1345 through which the throughbolts 1342 extend. The nuts 1344 can be welded to the bolts 1342 to enhance the connection between these components.

The panels and bracing of the deck 1330 can be made from stainless steel, other metal alloys, solid cast materials, or fiber-reinforced composites. For example, the panels and plates can be made from Nitronic 50 stainless steel, Hastelloy 625 steel alloys, or a solid cast epoxy filled with mica. The fiber-reinforced composites can include a carbon-fiber or Kevlar® mesh in a hardened resin. The material for the panels 1331 and 1332 should be highly rigid and compatible with the chemicals used in the wet chemical processes. Stainless steel is well-suited for many applications because it is strong but not affected by many of the electrolytic solutions or cleaning solutions used in wet chemical processes. In one embodiment, the panels and plates 1331, 1332, 1360, 1361, 1362 and 1364 are 0.125 to 0.375 inch thick stainless steel, and more specifically they can be 0.250 inch thick stainless steel. The panels and plates, however, can have different thickness in other embodiments.

The bracing 1340 can also be stainless steel, fiber-reinforced composite materials, other metal alloys, and/or solid cast materials. In one embodiment, the bracing can be 0.5 to 2.0 inch wide stainless steel joists, and more specifically 1.0 inch wide by 2.0 inches tall stainless steel joists. In other embodiments the bracing 1340 can be a honey-comb core, a light-weight foamed metal or other type of foam, polymers, fiber glass or other materials.

The mounting module 1320 is constructed by assembling the sections of the deck 1330, and then welding or otherwise adhering the end plates 1362 and 1364 to the sections of the deck 1330. The components of the deck 1330 are generally secured together by the throughbolts 1342 without welds. The outer side plates 1360 and the interior side plates 1361 are attached to the deck 1330 and the end plates 1362 and 1364 using welds and/or fasteners. The platform 1350 is then securely attached to the end plates 1362 and 1364, and the interior side plates 1361.

The mounting module 1320 provides a heavy-duty, dimensionally stable structure that maintains the relative positions between the positioning elements 1334 on the deck 1330 and the positioning elements 1354 on the platform 1350 within a range that does not require the transport system 1390 to be recalibrated each time a replacement processing chamber 1370 or lift-rotate unit 1380 is mounted to the deck 1330. The mounting module 1320 is generally a rigid structure that is sufficiently strong to maintain the relative positions between the positioning elements 1334 and 1354 when the wet chemical processing chambers 1370, the lift-rotate units 1380, and the transport system 1390 are mounted to the mounting module 1320. In several embodiments, the mounting module 1320 is configured to maintain the relative positions between the positioning elements 1334 and 1354 to within 0.025 inch of predetermined reference positions. In other embodiments, the mounting module is configured to maintain the relative positions between the positioning elements 1334 and 1354 to within approximately 0.005 to 0.015 inch of predetermined reference positions. As such, the deck 1330 often maintains a uniformly flat surface to within approximately 0.025 inch, and in more specific embodiments to approximately 0.005-0.015 inch.

G. Embodiments of Wet Chemical Processing Chambers

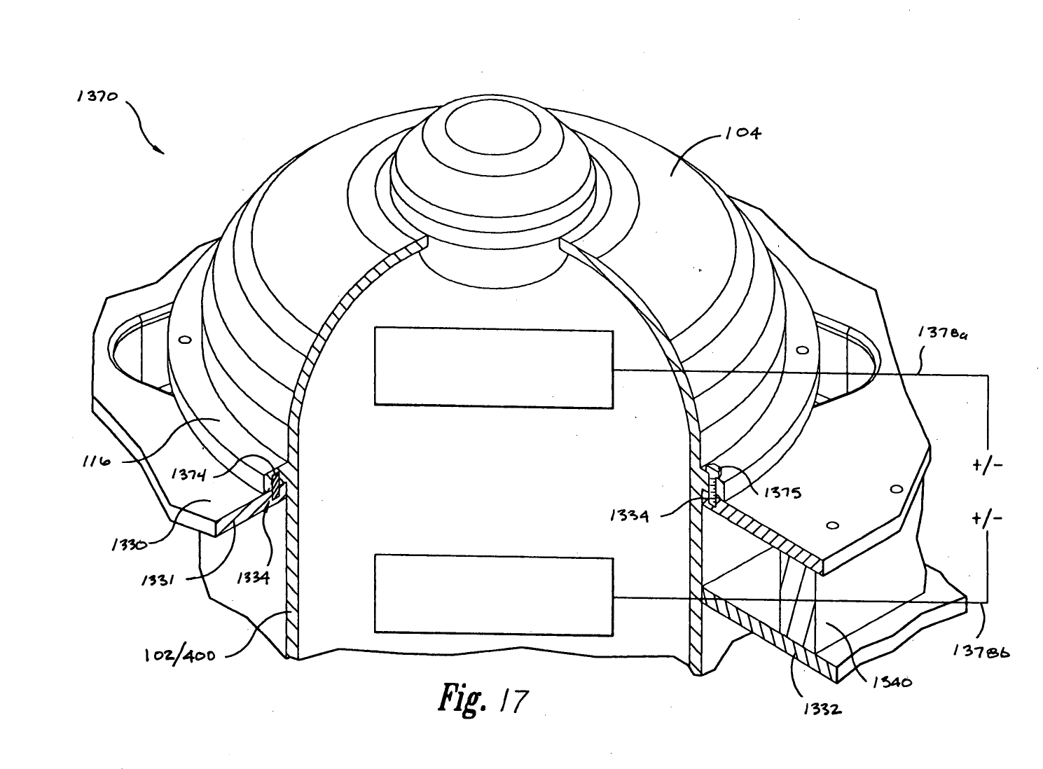

FIG. 17 is an isometric cross-sectional view showing the interface between a wet chemical processing chamber 1370 and the deck 1330. The chamber 1370 can include the processing vessels 102 or 400 described above with the mounting fixture 116. The mounting fixture 116 and the vessel 102/400 can be separate components that are connected together. In such cases, the mounting fixture 116 can be made from a dimensionally stable material, such as stainless steel, fiber-reinforced materials, steel alloys, cast solid materials, or other suitably rigid materials. In other embodiments, the mounting fixture 116 is integral with the vessel 102/400 and formed from a high-density polymer or other suitable material.

The mounting fixture 116 shown in FIG. 17 includes a plurality of interface members 1374 arranged in a pattern to be aligned with the positioning elements 1334 on the deck 1330. The positioning elements 1334 and the interface members 1374 are also configured to mate with one another to precisely position the mounting fixture 116, and thus the chamber 1370, at a desired operating location on the deck 1330 to work with lift-rotate unit 1380 and the transport system 1390. The positioning elements 1334 can be a set of precisely machined holes in the deck 1330 and dowels received in the holes, and the interface members 1374 can be holes precisely machined in the mounting fixture 116 to mate with the dowels. The dowels can be pins with cylindrical, spherical, conical or other suitable shapes to align and position the mounting fixture 116 at a precise location relative to the deck 1330. The mounting fixture 116 can further include a plurality of fasteners 1375 arranged to be aligned with the attachment elements 1335 in the deck 1330. The fasteners 1375 can be bolts or other threaded members that securely engage the attachment elements 1335 to secure the mounting fixture 116 to the deck 1330. The mounting fixture 116 accordingly holds the processing vessel 102/400 at a fixed, precise location on the deck.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A chamber for wet chemical processing of microfeature workpieces, comprising:
a fixed unit having a first flow system configured to direct a processing fluid through the fixed unit and a mounting fixture for fixedly attaching the fixed unit to a support member of a tool;
a detachable unit having a second flow system configured to direct the processing fluid to and/or from the first flow system of the fixed unit and a processing component that imparts a property to the processing fluid for processing a surface on a microfeature workpiece having submicron microfeatures; and
an attachment system releasably coupling the detachable unit to the fixed unit, wherein the attachment system has a first position in which the detachable unit is secured to the fixed unit and a second position in which the detachable unit can be detached from the fixed unit.

2. The chamber of claim 1, further comprising a head positioned over the fixed unit, wherein the head comprises a workpiece holder configured to hold the workpiece at a processing site.

3. The chamber of claim 1 wherein:
the processing component comprises an electrode in the detachable unit; and
the chamber further comprises a head having a workpiece holder including electrical contacts configured to hold a workpiece at the processing site and engage a conductive layer on the workpiece.

4. The chamber of claim 1 wherein:
the processing component comprises an electrode assembly having a plurality of independently operable electrodes separated from each other by dielectric dividers, and the electrode assembly being positioned in the detachable unit; and
the chamber further comprises a head having a workpiece holder including electrical contacts configured to hold a workpiece at a processing site and engage a conductive layer on the workpiece.

5. The chamber of claim 1 wherein the processing component comprises a filter in the detachable unit.

6. The chamber of claim 1 wherein the processing component comprises a membrane configured to conduct electrical current across the membrane.

7. The chamber of claim 1 wherein the attachment assembly comprises a clamp ring configured to move radially inwardly from a first position to a second position to clamp the detachable unit to the fixed unit.

8. The chamber of claim 1, further comprising a seal between a first seal surface of the fixed unit and a second seal surface of the detachable unit.

9. The chamber of claim 1 wherein:
the fixed unit further comprises a beveled guide surface inclined upwardly with increasing radius, a beveled bearing ring having a bearing surface inclined upwardly with decreasing radius, and a first seal surface;
a detachable unit further comprises a rim having a lower surface inclined upwardly with increasing radius, an upper surface inclined upwardly with increasing radius, and a second seal surface; and
a seal between the first and second seal surfaces.

10. The chamber of claim 1 wherein:
the processing component comprises an electrode in the detachable unit; and
the chamber further comprises (a) a head having a workpiece holder including electrical contacts configured to hold a workpiece at a processing site and engage a conductive layer on the workpiece, and (b) a seal between a portion of the fixed unit and the detachable unit.

11. The chamber of claim 1 wherein:
the processing component comprises an electrode in the detachable unit and a filter between the electrode and a processing site; and
the chamber further comprises (a) a head having a workpiece holder including electrical contacts configured to hold a workpiece at a processing site and engage a conductive layer on the workpiece, and (b) a seal between a portion of the fixed unit and the detachable unit.

12. The chamber of claim 1 wherein:
the processing component comprises an electrode in the detachable unit and a membrane between the electrode and a processing site, wherein the membrane is configured to conduct electrical current; and
the chamber further comprises (a) a head having a workpiece holder including electrical contacts configured to hold a workpiece at a processing site and engage a conductive layer on the workpiece, and (b) a seal between a portion of the fixed unit and the detachable unit.

13. A chamber for wet chemical processing of microfeature workpieces, comprising:
a fixed unit having a first flow system configured to direct a processing fluid through the fixed unit and a mounting fixture for fixedly attaching the fixed unit to a support surface of a tool;
a detachable unit releasably coupled to the fixed unit, the detachable unit having a second flow system configured to direct the processing fluid to and/or from the first flow system of the fixed unit;
a seal between the fixed unit and the detachable unit to prevent processing fluid from leaking between the fixed unit and the detachable unit, the seal having an orifice through which processing fluid can flow between the first and second flow systems; and
a processing component disposed in the fixed unit and/or the detachable unit, wherein the processing component imparts a property to the processing fluid for processing a surface on a microfeature workpiece having submicron microfeatures.

14. The chamber of claim 13, further comprising a head positioned over the fixed unit, wherein the head comprises a workpiece holder configured to hold the workpiece at the processing site.

15. The chamber of claim 13 wherein:
the processing component comprises an electrode in the detachable unit; and
the chamber further comprises a head having a workpiece holder including electrical contacts configured to hold a workpiece at the processing site and engage a conductive layer on the workpiece.

16. The chamber of claim 13 wherein:
the processing component comprises an electrode assembly having a plurality of independently operable electrodes separated from each other by dielectric dividers, and the electrode assembly being positioned in the detachable unit; and
the chamber further comprises a head having a workpiece holder including electrical contacts configured to hold a workpiece at the processing site and engage a conductive layer on the workpiece.

17. The chamber of claim 13 wherein the processing component comprises a filter in the detachable unit.

18. The chamber of claim 13 wherein the processing component comprises a membrane in the detachable unit, and the membrane being configured to conduct electrical current across the membrane.

19. The chamber of claim 13, further comprising an attachment assembly having a clamp ring configured to move radially inwardly from a first position to a second position to clamp the detachable unit to the fixed unit.

20. The chamber of claim 13 wherein:
the processing component comprises an electrode in the detachable unit and a filter between the electrode and the processing site; and
the chamber further comprises a head having a workpiece holder including electrical contacts configured to hold a workpiece at the processing site and engage a conductive layer on the workpiece.

21. The chamber of claim 13 wherein:
the processing component comprises an electrode in the detachable unit and a membrane between the electrode and the processing site, wherein the membrane is configured to conduct electrical current; and
the chamber further comprises a head having a workpiece holder including electrical contacts configured to hold a workpiece at the processing site and engage a conductive layer on the workpiece.

22. An integrated tool for wet chemical processing of microfeature workpieces, comprising:
a mounting module having a plurality of positioning elements and attachment elements;
a wet chemical processing chamber carried by the mounting module, the wet chemical processing chamber comprising a fixed unit, a detachable unit, an attachment system and a processing site, wherein (a) the fixed unit has a first flow system configured to direct a processing fluid through the fixed unit and a mounting fixture having a first interface member engaged with one of the positioning elements and a first fastener engaged with one of the attachment elements, (b) the detachable unit has a second flow system configured to direct the processing fluid to and/or from the first flow system of the fixed unit and a processing component that imparts a property to the processing fluid for processing a surface on a microfeature workpiece having submicron microfeatures, (c) the attachment system releasably couples the detachable unit to the fixed unit, and (d) the processing site is configured to receive the microfeature workpiece, the processing site being disposed in one of the fixed unit or the detachable unit to contact the workpiece with a portion of the processing fluid having the property imparted by the processing component;
a transport system carried by the mounting module for transporting the workpiece within the tool; and
wherein the mounting module is configured to maintain relative positions between positioning elements such that the transport system does not need to be recalibrated when the processing chamber is replaced with another processing chamber.

23. The tool of claim 22 wherein the mounting module further comprises a deck having a rigid first panel, a rigid second panel superimposed under the first panel, joists between the first and second panel, and bolts through the first panel, the joists and the second panel.

24. The tool of claim 22 wherein the mounting module further comprises a deck having a rigid first panel, a rigid second panel juxtaposed to the first panel, and bracing between the first and second panels.

25. The tool of claim 24, further comprising a head positioned over the fixed unit, wherein the head comprises a workpiece holder configured to hold the workpiece at the processing site.

26. The tool of claim 24 wherein:
the processing component comprises an electrode in the detachable unit; and
the chamber further comprises a head having a workpiece holder including electrical contacts configured to hold a workpiece at the processing site and engage a conductive layer on the workpiece.

27. The tool of claim 24, further comprising a seal between a first seal surface of the fixed unit and a second seal surface of the detachable unit.

28. The tool of claim 24 wherein:
the processing component comprises an electrode in the detachable unit; and
the chamber further comprises (a) a head having a workpiece holder including electrical contacts configured to hold a workpiece at the processing site and engage a conductive layer on the workpiece, and (b) a seal between a portion of the fixed unit and the detachable unit.

29. The tool of claim 24 wherein:
the processing component comprises an electrode in the detachable unit and a filter between the electrode and the processing site; and
the chamber further comprises (a) a head having a workpiece holder including electrical contacts configured to hold a workpiece at the processing site and engage a conductive layer on the workpiece, and (b) a seal between a portion of the fixed unit and the detachable unit.

30. The tool of claim 24 wherein:
the processing component comprises an electrode in the detachable unit and a membrane between the electrode and the processing site, wherein the membrane is configured to conduct electrical current; and
the chamber further comprises (a) a head having a workpiece holder including electrical contacts configured to hold a workpiece at the processing site and engage a conductive layer on the workpiece, and (b) a seal between a portion of the fixed unit and the detachable unit.

31. An integrated tool for wet chemical processing of microfeature workpieces, comprising:
a mounting module having a plurality of positioning elements;
a wet chemical processing chamber carried by the mounting module, the wet chemical processing chamber comprising a fixed unit, a detachable unit releasably coupled to the fixed unit, a seal between the fixed unit and the detachable unit, and processing component disposed in the detachable unit, wherein the fixed unit includes a mounting fixture having a first interface member engaged with one of the positioning elements and a first fastener engaged with one of the positioning elements;
a transport system carried by the mounting module for transporting the workpiece within the tool, the transport system having a second interface member engaged with one of the positioning elements and a second fastener engaged with one of the attachment elements; and
wherein the mounting module is configured to maintain relative positions between positioning elements such that the transport system does not need to be recalibrated when the processing chamber is replaced with another processing chamber.

32. The tool of claim 31 wherein the mounting module further comprises a deck having a rigid first panel, a rigid second panel superimposed under the first panel, joists between the first and second panel, and bolts through the first panel, the joists and the second panel.

33. The tool of claim 31 wherein the mounting module further comprises a deck having a rigid first panel, a rigid second panel juxtaposed to the first panel, and bracing between the first and second panels.

34. The tool of claim 31 further comprising a head positioned over the fixed unit, wherein the head comprises a workpiece holder configured to hold the workpiece at the processing site.

35. The tool of claim 31 wherein:
the processing component comprises an electrode in the detachable unit; and
the chamber further comprises a head having a workpiece holder including electrical contacts configured to hold a workpiece at the processing site and engage a conductive layer on the workpiece.

36. An electrochemical deposition chamber for depositing material onto microfeature workpieces having submicron features, comprising:
a head assembly having a workpiece holder configured to position a microfeature workpiece at a processing site;
a fixed unit having a first flow system to provide a processing fluid to the processing site;
a detachable unit having a second flow system in fluid communication with the first flow system of the fixed unit;
a seal to prevent leaking of the processing fluid between the fixed unit and the detachable unit;
an attachment assembly releasably coupling the detachable unit to the fixed unit; and
at least a first electrode in the detachable unit and at least a first electrical connector coupled to the first electrode.

37. The chamber of claim 36, further comprising a second electrode in the detachable unit and a dielectric divider between the first electrode and the second electrode.

38. The chamber of claim 36, further comprising a filter in the first flow system and/or the second flow system.

39. The chamber of claim 36, further comprising a membrane in the first flow system and/or the second flow system, wherein the membrane is configured to conduct electrical current.

40. The chamber of claim 36, wherein the attachment assembly comprises a clamp ring configured to move radially inwardly from a first position to a second position to clamp the detachable unit to the fixed unit.

41. The chamber of claim 36 wherein:
the fixed unit further comprises a beveled guide surface inclined upwardly with increasing radius, a beveled bearing ring having a bearing surface inclined upwardly with decreasing radius, and a first seal surface contacting one side of the seal; and
the detachable unit further comprises a rim having a lower surface inclined upwardly with increasing radius, an upper surface inclined upwardly with increasing radius, and a second seal surface contacting another side of the seal.

42. The chamber of claim 36 wherein the fixed unit further comprises a field shaping module that shapes an electrical field in the processing fluid induced by the electrode.

43. The chamber of claim 36, further comprising:
a second electrode arranged concentrically with the first electrode in the detachable unit; and
a field shaping module in the fixed unit, wherein the field shaping module is composed of a dielectric material and has a first opening facing a first section of the processing site through which ions influenced by the first electrode can pass and a second opening facing a second section of the processing site through which ions influenced by the second electrode can pass.

44. The chamber of claim 43, further comprising a second electrical connector coupled to the second electrode, and the first and second electrodes are operable independently from each other.

45. The chamber of claim 36, further comprising:
a second electrode concentric with the first electrode in the detachable unit and a dielectric divider between the first and second electrodes;
a field shaping module in the fixed unit, the field shaping module being composed of a dielectric material configured to shape electrical fields in the processing fluid generated by the first and second electrodes; and
a filter in the fixed unit and/or the detachable unit.

46. The chamber of claim 36, further comprising:
a second electrode concentric with the first electrode in the detachable unit and a dielectric divider between the first and second electrodes;
a field shaping module in the fixed unit, the field shaping module being composed of a dielectric material configured to shape electrical fields in the processing fluid generated by the first and second electrodes; and
a membrane in the fixed unit and/or the detachable unit that conducts electrical current.

47. The chamber of claim 36 wherein the detachable unit is positioned externally underneath the fixed unit.

48. The chamber of claim 36 wherein the detachable unit further includes an externally accessible fluid fitting through which the processing fluid can flow.

49. An electrochemical deposition chamber for depositing material onto microfeature workpieces having submicron features, comprising:
a head assembly having a workpiece holder configured to position a microfeature workpiece at a processing site and electrical contacts arranged to provide electrical current to a layer on the workpiece;
a vessel having a fixed unit including a mounting fixture to attach the fixed unit to a deck of a tool, an externally accessible detachable unit releasably attachable to the fixed unit below the mounting fixture to be positioned below the deck of the tool, an interface element between the fixed unit and the detachable unit to control processing fluid between the fixed unit and the detachable unit, and an attachment assembly releasably coupling the detachable unit to the fixed unit; and
an electrode in the detachable unit.

50. The chamber of claim 49, further comprising a second electrode in the detachable unit and a dielectric divider between the first electrode and the second electrode.

51. The chamber of claim 49, further comprising a filter in the vessel.

52. The chamber of claim 49, further comprising a membrane in the vessel configured to conduct electrical current.

53. The chamber of claim 49, wherein the attachment assembly comprises a clamp ring configured to move radially inwardly from a first position to a second position to clamp the detachable unit to the fixed unit.

54. The chamber of claim 49 wherein:
the interface element comprises a gasket between the fixed unit and the detachable unit; and
an externally accessible fluid fitting through which processing fluid can flow.

55. The chamber of claim 49, further comprising:
a flow system in the vessel configured to direct a flow of processing fluid to be at least substantially normal to a workpiece at the processing site; and
a field shaping module in the vessel that shapes an electrical field in the processing fluid induced by the electrode.

56. The chamber of claim 49, further comprising:
a second electrode arranged concentrically with the first electrode in the detachable unit; and
a field shaping module in the vessel, the field shaping module being composed of a dielectric material, and the field shaping module having a first opening facing a first section of a workpiece processing site through which ions influenced by the first electrode can pass and a second opening facing a second section of the workpiece processing site through which ions influenced by the second electrode can pass.

57. The chamber of claim 49, further comprising:
a second electrode concentric with the first electrode in the detachable unit and a dielectric divider between the first and second electrodes;
a field shaping module in the vessel, the field shaping module being configured to shape electrical fields in the processing fluid generated by the first and second electrodes;
a flow system in the vessel having a wall that directs a flow of processing fluid to be at least substantially normal to a workpiece at the processing site; and
filter in the vessel in fluid communication with the processing fluid.

58. The chamber of claim 49 wherein:
a second electrode concentric with the first electrode in the detachable unit and a dielectric divider between the first and second electrodes;
a field shaping module in the vessel, the field shaping module being configured to shape electrical fields in a processing fluid within the vessel generated by the first and second electrodes;
a flow system in the vessel having a wall that directs the processing fluid to be at least substantially normal to a workpiece at the processing site; and
a membrane in the vessel that conducts an electrical current in the processing fluid.

59. An integrated tool for wet chemical processing of microfeature workpieces, comprising:
a mounting module having a plurality of positioning elements and attachment elements;
an electrochemical deposition chamber comprising a head assembly having a workpiece holder configured to position a microfeature workpiece at a processing site, a fixed unit having a first flow system to provide a processing fluid to the processing site and a mounting fixture for fixedly attaching the fixed unit to a support member of a tool, a detachable unit having a second flow system in fluid communication with the first flow system of the fixed unit, a seal to prevent leaking of the processing fluid between the fixed unit and the detachable unit, an attachment assembly releasably coupling the detachable unit to the fixed unit, and at least a first electrode in the detachable unit;
a transport system carried by the mounting module for transporting the workpiece within the tool, the transport system having a second interface member engaged with one of the positioning elements and a second fastener engaged with one of the attachment elements; and
wherein the mounting module is configured to maintain relative positions between positioning elements such that the transport system does not need to be recalibrated when the processing chamber is replaced with another processing chamber.

60. The tool of claim 59 wherein the mounting module further comprises a deck having a rigid first panel, a rigid second panel superimposed under the first panel, joists between the first and second panel, and bolts through the first panel, the joists and the second panel.

61. The tool of claim 59 wherein the mounting module further comprises a deck having a rigid first panel, a rigid second panel juxtaposed to the first panel, and bracing between the first and second panels.

62. The tool of claim 59, further comprising a second electrode in the detachable unit and a dielectric divider between the first electrode and the second electrode.

63. The tool of claim 59, further comprising a filter in the first flow system and/or the second flow system.

64. The tool of claim 59, further comprising a membrane in the first flow system and/or the second flow system, wherein the membrane is configured to conduct electrical current.

65. The tool of claim 59, wherein the attachment assembly comprises a clamp ring configured to move radially inwardly from a first position to a second position to clamp the detachable unit to the fixed unit.

66. The tool of claim 59 wherein:
the fixed unit further comprises a beveled guide surface inclined upwardly with increasing radius, a beveled bearing ring having a bearing surface inclined upwardly with decreasing radius, and a first seal surface contacting one side of the seal; and
the detachable unit further comprises a rim having a lower surface inclined upwardly with increasing radius, an upper surface inclined upwardly with increasing radius, and a second seal surface contacting another side of the seal.

67. The tool of claim 59 wherein the fixed unit further comprises a field shaping module that shapes an electrical field in the processing fluid induced by the electrode.

68. The tool of claim 59 further comprising:
a second electrode arranged concentrically with the first electrode in the detachable unit; and
a field shaping module in the fixed unit, wherein the field shaping module is composed of a dielectric material and has a first opening facing a first section of the processing site through which ions influenced by the first electrode can pass and a second opening facing a second section of the processing site through which ions influenced by the second electrode can pass.

69. The tool of claim 68 further comprising a second electrical connector coupled to the second electrode, and the first and second electrodes are operable independently from each other.

70. The tool of claim 49 further comprising:
a second electrode concentric with the first electrode in the detachable unit and a dielectric divider between the first and second electrodes;
a field shaping module in the fixed unit, the field shaping module being composed of a dielectric material configured to shape electrical fields in the processing fluid generated by the first and second electrodes; and
a filter in the fixed unit and/or the detachable unit.

71. The tool of claim 49 further comprising:
a second electrode concentric with the first electrode in the detachable unit and a dielectric divider between the first and second electrodes;
a field shaping module in the fixed unit, the field shaping module being composed of a dielectric material configured to shape electrical fields in the processing fluid generated by the first and second electrodes; and
a membrane in the fixed unit and/or the detachable unit that conducts electrical current.

72. An integrated tool for wet chemical processing of microfeature workpieces, comprising:
a mounting module having a plurality of positioning elements and attachment elements;
an electrochemical deposition chamber comprising a head assembly and a vessel, the head assembly having a workpiece holder configured to position a microfeature workpiece at a processing site and electrical contacts arranged to provide electrical current to a layer on the workpiece, and the vessel having a fixed unit including a mounting fixture to attach the fixed unit to a deck of a tool, an externally accessible detachable unit releasably attachable to the fixed unit below the mounting fixture to be positioned below the deck of the tool, an interface element between the fixed unit and the detachable unit to control processing fluid between the fixed unit and the detachable unit, an electrode in the detachable unit, and an attachment assembly releasably coupling the detachable unit to the fixed unit;
a transport system carried by the mounting module for transporting the workpiece within the tool, the transport system having a second interface member engaged with one of the positioning elements and a second fastener engaged with one of the attachment elements; and
wherein the mounting module is configured to maintain relative positions between positioning elements such that the transport system does not need to be recalibrated when the processing chamber is replaced with another processing chamber.

73. The tool of claim 72 wherein the mounting module further comprises a deck having a rigid first panel, a rigid second panel superimposed under the first panel, joists between the first and second panel, and bolts through the first panel, the joists and the second panel.

74. The tool of claim 72 wherein the mounting module further comprises a deck having a rigid first panel, a rigid second panel juxtaposed to the first panel, and bracing between the first and second panels.

75. The tool of claim 72, further comprising a second electrode in the detachable unit and a dielectric divider between the first electrode and the second electrode.

76. The tool of claim 72, further comprising a filter in the vessel.

77. The tool of claim 72, further comprising a membrane in the vessel configured to conduct electrical current.

78. The tool of claim 72, wherein the attachment assembly comprises a clamp ring configured to move radially inwardly from a first position to a second position to clamp the detachable unit to the fixed unit.

79. The tool of claim 72 wherein:
the interface element comprises a gasket between the fixed unit and the detachable unit;
the fixed unit further comprises a beveled guide surface inclined upwardly with increasing radius, a beveled bearing ring having a bearing surface inclined upwardly with decreasing radius, and a first seal surface contacting one side of the gasket; and
the detachable unit further comprises a rim having a lower surface inclined upwardly with increasing radius, an upper surface inclined upwardly with increasing radius, and a second seal surface contacting another side of the gasket.

80. The tool of claim 72, further comprising:
a flow system in the vessel configured to direct a flow of processing fluid to be at least substantially normal to a workpiece at the processing site; and
a field shaping module in the vessel that shapes an electrical field in the processing fluid induced by the electrode.

81. The tool of claim 72, further comprising:
a second electrode arranged concentrically with the first electrode in the detachable unit; and
a field shaping module in the vessel, the field shaping module being composed of a dielectric material, and the field shaping module having a first opening facing a first section of a workpiece processing site through which ions influenced by the first electrode can pass and a second opening facing a second section of the workpiece processing site through which ions influenced by the second electrode can pass.

82. The tool of claim 72, further comprising:
a second electrode concentric with the first electrode in the detachable unit and a dielectric divider between the first and second electrodes;
a field shaping module in the vessel, the field shaping module being configured to shape electrical fields in the processing fluid generated by the first and second electrodes;
a flow system in the vessel having a wall that directs a flow of processing fluid to be at least substantially normal to a workpiece at the processing site; and
filter in the vessel in fluid communication with the processing fluid.

83. The tool of claim 72, further comprising:
a second electrode concentric with the first electrode in the detachable unit and a dielectric divider between the first and second electrodes;
a field shaping module in the vessel, the field shaping module being configured to shape electrical fields in a processing fluid within the vessel generated by the first and second electrodes;
a flow system in the vessel having a wall that directs the processing fluid to be at least substantially normal to a workpiece at the processing site; and
a membrane in the vessel that conducts an electrical current in the processing fluid.

84. A method for electrochemically depositing material onto a workpiece in an electrochemical deposition chamber comprising a head assembly having a workpiece holder and a vessel having a fixed unit with a processing location, a first detachable unit releasably attached to the fixed unit, and a first electrode in the first detachable unit, the method comprising:
depositing a layer onto a first workpiece having submicron features by positioning the first workpiece at the processing location of the fixed unit to contact a processing fluid in the vessel and establishing an electrical field between the first workpiece and the first electrode;
replacing the first electrode by releasing the first detachable unit from the fixed unit, removing the detachable unit from underneath the fixed unit, positioning a second detachable unit with a second electrode underneath the fixed unit, and releasably attaching the second detachable unit to the fixed unit; and
depositing a layer onto a second workpiece having submicron features by positioning the second workpiece at the processing location of the fixed unit to contact a processing fluid in the vessel and establishing an electrical field between the second workpiece and the second electrode.

85. A method of servicing an electrochemical chamber for depositing material onto a workpiece having submicron features, the method comprising:
providing an electrochemical deposition chamber comprising a head assembly having a workpiece holder and a vessel having a fixed unit with a processing location, a first detachable unit releasably attached to the fixed unit, and a first electrode in the first detachable unit;
removing the first detachable unit from the fixed unit by disconnecting the detachable unit from the fixed unit at an external location outside of the fixed unit; and
releasably attaching a second detachable unit having a second electrode to a portion of the fixed unit.
